(19) United States
(12) Patent Application Publication
(10) Pub. No.: US 2014/0002366 A1
(43) Pub. Date: Jan. 2, 2014

(54) INPUT DEVICE WITH THREE-DIMENSIONAL IMAGE DISPLAY

(71) Applicants: Jesper Glückstad, Frederiksberg (DK); Finn Pedersen, Roskilde (DK)

(72) Inventors: Jesper Glückstad, Frederiksberg (DK); Finn Pedersen, Roskilde (DK)

(21) Appl. No.: 13/977,040

(22) PCT Filed: Dec. 21, 2011
(86) PCT No.: PCT/EP11/73536

§ 371 Date: Sep. 17, 2013

(30) Foreign Application Priority Data
Dec. 30, 2010 (EP) 10197380.8

(51) Int. Cl. G06F 3/02; G09G 5/14

(52) U.S. Cl. CPC G06F 3/0202; G09G 5/14
USPC 345/168

(57) ABSTRACT

The present invention relates to an input device (2), such as a keyboard, comprising a plurality of activation parts (4) for depression, at least one registration part (6) for individual registration of depression of activation parts, and at least one image displaying part (8), where depression of the activation parts (4) provides tactile feedback to a user. The at least one image displaying part (8) is configured for displaying a label of an activation part (4) as a three-dimensional label.

The present invention relates to an input device, such as a keyboard or a control panel, comprising a plurality of parts configured for activation and registration by depression. The input device is configured for displaying a label of an activation part or key as a three-dimensional label.

Any discussion of prior art throughout this description should not be considered as an admission that such prior art is widely known or forms part of common general knowledge.

International patent publication number WO 2008/065195 discloses a keyboard having labels on the keys that can be changed during operation of the input device.

US application publication number US 2010/0295820 discloses a device where an image in the shape of a button may be projected onto a region so that a button is visible to a user at the region. Further, a raised topography of the region may provide a tactile reinforcement that the region is currently serving as a virtual button. Finally, a user touch directed to the region may be detected, for example as described above, thus allowing the region to provide working button functionality.

Further keyboards are known from the following US patent numbers: U.S. Pat. No. 6,444,888, U.S. Pat. No. 5,818,361, U.S. Pat. No. 4,491,692, and U.S. Pat. No. 5,515,045.

It is an object of the present invention to provide an input device that facilitates use of the input device.

According to the present invention, the above-mentioned and other objects are fulfilled by an input device comprising a plurality of activation parts, at least one registration part, and at least one image displaying part. The plurality of activation parts includes a first activation part and a second activation part. Each activation part is configured for enabling depression of the respective activation part by a user. The input device is configured such that depression of the activation part provides tactile feedback to the user. The at least one registration part is configured for individual registration of depression of activation parts. The at least one image displaying part includes a first image displaying part. The first image displaying part is configured for displaying a first image to the user. The display of the first image is configured to be perceived by the user as a three-dimensional or a pseudo three-dimensional first image at the first activation part. The first image may include a first primary label for the first activation part.

The present invention provides one or more of the following advantages: a more versatile indication of a label for an activation part of the input device, an improved access, an improved indication of how to use the input device, an improved and more intuitive indication of options of use of the input device.

It is furthermore an advantage of the present invention that the input device may be operated by the user in at least substantially the same way as a computer keyboard is operated. For example, a specific type of tactile feedback experienced by the user during use of a particular computer keyboard may be provided by the input device according to the present invention.

### BRIEF DESCRIPTION OF THE DRAWINGS

The above and other features and advantages of the present invention will become readily apparent to those skilled in the art by the following detailed description of exemplary embodiments thereof with reference to the attached drawings, in which the following is schematically illustrated:

FIG. 1 schematically illustrates a top view of an input device according to the present invention.

FIG. 2 schematically illustrates a side view of a part of the input device illustrated in FIG. 1.

FIG. 3 schematically illustrates a perspective view of a part of the at least one image displaying part of the input device illustrated in FIG. 2 or 6.

FIG. 4 schematically illustrates a top view of the part illustrated in FIG. 3.

FIG. 5 schematically illustrates the part illustrated in FIG. 3 including a primary label for each image displaying part.

FIG. 6 schematically illustrates a side view of a part of an input device according to the present invention.

FIG. 7 a) shows an embodiment of a dynamic display keyboard 100 comprising a lens element.

FIG. 7b shows an embodiment of a circular cross-sectional form along the X-X axis of a dome element.

FIG. 7c shows an embodiment of a square cross-sectional form along the X-X axis of a dome element.

FIG. 8 shows an embodiment of a dynamic display keyboard comprising a lens element.

FIG. 9 shows an embodiment in which a key element 101 of the dynamic display keyboard in a depressed state.

FIG. 10 shows an embodiment of the dynamic display keyboard further comprising a layer in which the key elements are included.

FIG. 11 shows an embodiment in which a key element of the dynamic display keyboard is in a depressed state

FIG. 12 shows an embodiment of the keyboard of FIG. 7 further comprising a transparent lens-formed layer in each of the key elements.

FIG. 13 shows an embodiment of the keyboard of FIG. 7 further comprising a lenslet-array.

FIG. 14 shows an embodiment of the keyboard of FIG. 7 further comprising a fiber-optic array comprising a plurality of optical fibers.

FIG. 15 shows an embodiment of the keyboard of FIG. 7 wherein the display unit comprises light-generating unit.

FIG. 16 shows an embodiment of the keyboard of FIG. 7 comprising a holographic laser projection (HLP) unit.

FIG. 17 shows an embodiment of a key in a dynamic keyboard comprising a scissor-switch.

FIG. 18a shows an embodiment of a dynamic display keyboard.

FIG. 18b shows an embodiment of a circular cross-sectional form along the X-X axis of a dome element.

FIG. 18c shows an embodiment of a square cross-sectional form along the X-X axis of a dome element.

FIG. 19 shows an embodiment of a dynamic display keyboard comprising a conducting fixator.

FIG. 20 shows an embodiment in which a key element 101 of the dynamic display keyboard comprising electrically conducting fixators is in a depressed state.

FIG. 21 shows an embodiment of the dynamic display keyboard further comprising a layer in which the key elements are included.

FIG. 22 shows an embodiment in which a key element of the dynamic display keyboard comprising a layer is in a depressed state.

FIG. 23 shows an embodiment of a key element.

FIG. 24 shows an embodiment of a device comprising a dynamic display keyboard comprising a detachable part and a light generating layer.

FIG. 25 shows an embodiment of a dynamic display keyboard providing an increased angle of view of the key elements.

FIG. 26a shows an embodiment of a dynamic display keyboard.

FIG. 26b shows an embodiment of a circular cross-sectional form along the X-X axis of a dome element.

FIG. 26c shows an embodiment of a square cross-sectional form along the X-X axis of a dome element.

FIG. 26 d) shows the display unit placed above the mat.

FIG. 27 shows an embodiment of a dynamic display keyboard comprising conducting fixators.

FIG. 28 shows an embodiment in which a key element of the dynamic display keyboard comprising electrically conducting fixators is in a depressed state.

FIG. 29 shows an embodiment of the dynamic display keyboard further comprising a layer in which the key elements are included.

FIG. 30 shows an embodiment in which a key element of the dynamic display keyboard is in a depressed state.

FIG. 31 shows an embodiment of a key in a dynamic keyboard comprising a scissor-element.

FIG. 32 shows an embodiment of a device comprising a dynamic display keyboard comprising a detachable part and a light generating layer.

FIG. 33 shows an embodiment 900 of the display unit 111 comprising a thin layer display unit 911.

FIG. 34 a) shows an embodiment of a key 1200 of a dynamic display keyboard.

FIG. 34 b) shows an embodiment of FIG. 34 a) in which the display unit 111 is placed above the mat 105.

FIG. 35a shows an embodiment of a system comprising a keyboard and a projector.

FIG. 35b shows an embodiment of a circular cross-sectional form along the X-X axis of a dome element.

FIG. 35c shows an embodiment of a square cross-sectional form along the X-X axis of a dome element.

FIG. 36 a) shows an embodiment of a mobile communication device comprising a smart phone and comprising a light projector.

FIG. 36 b) shows a top view of a mobile communication device comprising a light projector.

FIG. 37 a) shows a front view of a smart phone comprising a hinged mirror.

FIG. 37 b) shows a rear view of a smart phone comprising a hinged mirror.

FIG. 37 c) shows a side view of a smart phone comprising a hinged mirror in a slid-in state.

FIG. 37 d) shows a side view of a smart phone comprising a hinged mirror in a slid-out state.

FIG. 38 shows an embodiment of the keyboard further comprising a layer in which the key elements are included.

FIG. 39 shows an embodiment in which a key element of the keyboard is in a depressed state.

FIG. 40 a) shows a system comprising a mobile communication device comprising a light projector and further comprising a device comprising a docking bay.

FIG. 40 b) shows a system comprising a mobile communication device comprising a light projector and further comprising a device comprising a docking bay, wherein the mobile communication device is docked in the docking bay.

FIG. 41 a) shows a front view of a smart phone in which the top of the smart phone comprises a pico-projector.

FIG. 41 b) shows a side view of a smart phone in which a mirror redirects the light from the pico-projector.

FIG. 41 c) shows a rear view of a smart phone comprising a switch for switching the mirror in and out of the pico-projector light projection.

FIG. 42 a) shows the effect of skew angles which may occur when projecting a dynamic RGB colour image from a pico-projector onto the surface in front of the smart phone using a mirror.

FIG. 42 b) shows the projection of a dynamic RGB colour image from a pico-projector onto the surface in front of the smart phone using a mirror without skew effects.

FIG. 43 shows an embodiment of a smart phone comprising a hinged mirror with a flexible and bendable first mirror part.

FIG. 44 shows an embodiment of a smart phone comprising a hinged mirror with a thin phase shifting or lensing material coating 1011 included in the first mirror part.

The figures are schematic and simplified for clarity, and they may merely show details which are essential to the understanding of the invention, while other details may have been left out, e.g. for reasons of simplicity. Throughout, the same reference numerals are used for identical or corresponding parts.

It should be noted that in addition to the exemplary embodiments of the invention shown in the accompanying drawings, the invention may be embodied in different forms and should not be construed as limited to the embodiments set forth herein. Rather, these embodiments are provided so that this disclosure will be thorough and sufficient, and will fully convey the concept of the invention to those skilled in the art.

### DETAILED DESCRIPTION

The input device according to the present invention may be any device, such as a control panel (e.g. for an elevator, in a car, etc.) or a keyboard, such as a computer keyboard, comprising a plurality of activation parts in form of keys. The input device may form part of another device, such as a computer (e.g. a laptop computer), a telephone, a mobile phone, a tablet computer, etc.

A computer keyboard may be a typewriter keyboard, which uses an arrangement of buttons or keys, to act as mechanical levers, electronic switches, or for activation of any suitable registration part.

The input device may for instance be used with a computer, an electronic game, a toy, a musical instrument, a money dispenser, a sales terminal, or another terminal, or electronic device, such as a telephone, etc.

The input device may be used in connection with applications for a computer for learning, games, graphical production, music production, typing of mathematical formulas or equations, or for any other purpose where a large number (such as above 50 or above 100) of symbols and/or characters needs to be accessible for typing in.

The activation parts represent respective parts of the input device, which parts the user may actuate individually, e.g. by depression by means of a finger of the user.

The activation part may comprise a surface part, such as the upper surface part. The activation part may be configured to be depressed directly by the user, or may be configured to be depressed through an overlaying part, such as a cover, such as a flexible cover. A depression of the activation part may generate a motion of the activation part, which motion may be transferred to the registration part (or a part thereof), e.g. by direct motion of the registration part (or a part thereof) via a rigid connection between activation part and the registration part. The activation part may be moveably or communicately connected with the registration part.

The upper surface part of an activation part, such as the cap part of a key, may be substantially squared, such as squared with rounded edges, such as a shape of a key cap of a computer keyboard. The dimensions of an upper surface part of an activation part may have a first length from 1 to 2 cm and a second length from 1 to 2 cm.

The tactile feedback relates to how it feels to depress an activation part. For example, whether a “click” is generated by an activation part when the activation part is depressed by the user and how the “click” may feel and/or sound. Tactile feedback may relate to the length of linear displacement of the activation part when depressed by the user. The input device may comprise a dome and/or a scissor-switch element for each activation part, e.g. for each key, for generating the tactile feedback to be provided to the user by the activation part, i.e. via the activation part. The input device may comprise a guide for each activation part for guiding the depression of the respective activation part substantially along a respective linear axis. The guide may be provided by means of the scissor-switch and/or the dome. Thus, the activation part may be arranged for a linear motion when activated.

The linear motion or travel distance of the activation part from a position in rest to a position of registration may for instance be from 1 to 3 mm such as about 2 mm.

The registration part may comprise an electronic circuit or may be configured to short-circuit an electronic circuit. Alternatively or in combination, the registration part may be configured to influence propagation of light towards a light detector for enabling registration of an activation of the activation part.

The at least one image displaying part is configured for displaying an image to be perceived as a three-dimensional or pseudo three-dimensional image at an activation part. In this context, “at an activation part” may include: within, under, above, around, next to the activation part, or any combination of the aforementioned prepositions, such as above and within the activation part. Thus, a respective image may appear to be within and/or around a volume of a respective activation part, such as being above and/or under the respective activation part.

A respective image displaying part refers to a part of the input device that is configured to display an image to the user. Display of an image may for instance be by generation of the image information to be displayed to the user, or it may be by being configured for imaging of light containing image information, which light is projected onto the image displaying part from a source that may generate image information to be displayed.

Individual images may be displayed at each activation part. The image at an activation part may display one or more labels associated with the activation part. Thus, when looking at a respective activation part, the user may be able to see an image displayed to the user, which image may represent one or more labels of the respective activation part.

Perception of an image as a three-dimensional or pseudo three-dimensional first image is an essential part of the present invention. Numerous methods of generation of so-called three-dimensional images exist. References to three-dimensional images are however often only a pseudo three-dimensional image in form of a stereoscopic or auto-stereoscopic image. A three-dimensional image may for instance be a holographic image.

In the context of the present invention, a stereoscopic image is an image comprising a first image part for a first eye of the user and a second image part for a second eye of the user. The same applies for an auto-stereoscopic image. An auto-stereoscopic image may furthermore be perceived as a first image part for a first eye and a second image part for a second eye without needing specific decoder devices in front of one or both eyes, such as a pair of glasses comprising a first decoder part for the first eye and a second decoder device for the second eye.

Throughout the present description, the abbreviation 3D is to be interpreted as three-dimensional or pseudo three-dimensional, where pseudo three-dimensional covers any method or technique of displaying something to a user such that the user gets an impression or illusion of viewing something in three dimensions. Pseudo three-dimensional techniques may for instance include: stereoscopic and auto-stereoscopic methods as known in the art of 3D image display. Thus, any method of generation of a 3D image or of generation of an illusion of a 3D image may be included in the present invention.

The input device and/or the first image displaying part may be configured to display the first image (and/or any other image of the input device) dynamically, i.e. e.g. such that the first image may be altered during and/or before user operation of the input device. Thus, an improved versatility is provided.

A combination of displaying in 3D and displaying dynamic may be referred to as displaying in four dimensions, i.e. e.g. abbreviated “4D”.

For known computer keyboards, several symbols (labels) may be provided for a single key, e.g. in the row normally displaying the numbers 1-9 and 0 (primary labels), where one or two other symbols (labels) are also printed on a top part (cap part) of the respective key. For instance, on a computer keyboard with a Danish layout, the key comprising the label “7” as the primary label furthermore comprises the labels “/” and “{” as secondary and tertiary labels.

The input device may be a keyboard, e.g. a computer keyboard, with a plurality of keys. The plurality of keys may include a first key and a second key. The first key may have a first cap part. The second key may have a second cap part. The first activation part may at least partly form the first cap part or the first cap part may include the first activation part. The second activation part may at least partly form the second cap part or the second cap part may include the second activation part.

A 3D image may enable that a plurality of labels of an activation part are presented at different heights or levels, e.g. a primary label may be displayed at a primary level and a secondary label may be displayed at a secondary level. Thus, in improved user friendliness may be provided.

The input device as configured for dynamic display, e.g. in form of a keyboard (a dynamic display keyboard), such as a computer keyboard, may be provided such that by depressing a modifier key (activation part), such as a “ctrl”, “shift, or “alt” key, the labels composing the plurality of labels may change position in 3D such that the label (i.e. the active label) that corresponds to the signal that will be generated if the respective key is depressed, is highlighted and/or is positioned above the other label(s) of the respective key. Thus, an indication of the selection, e.g. by means of a modifier key, of a label (the active label) of a key or an activation part may be improved by the present invention.

The at least one image displaying part may be configured for displaying a second image to the user. The display of the second image may be configured to be perceived by the user as a three-dimensional or a pseudo three-dimensional second image at the second activation part. The second image may include a second primary label for the second activation part.

The first image may include a first secondary label for the first activation part. The second image may include a second secondary label for the second activation part.

The at least one image displaying part may comprise a plurality of image displaying parts including a second image displaying part configured to displaying to the user the second image.

The plurality of imaging displaying parts may comprise an image displaying part for each activation part.

The input device configured for displaying the first image dynamically may for instance be configured such that one or more images associated with respective activation parts (or keys) may be altered or amended in response to events occurring in a program controlled using the input device. For instance, if a user is expected to activate one activation part out of a limited group of the plurality of activation parts, the images related to that particular limited group may be highlighted and thereby enabling an improved interaction. The highlighting may for instance involve that a part of the respective image appears to move, and/or by having one or more labels of the highlighted activation parts appearing to be moved on top of the respective activation parts.

The input device may have keys with labels that can be adapted or amended during operation of the input device, e.g. in order to display one or more symbols and/or icons as a label that indicates a current function of a respective activation part or key of the input device. Thus, dynamically displaying labels may enable change between different letters and/or symbols and/or short-cuts.

Provision of an input device configured for displaying dynamically may enable that symbols on a computer keyboard may be adapted, e.g. according to a type of keyboard layout a user is used to, e.g. a specific keyboard layout as utilized in a specific country. Thus, the input device may be adapted to present key labels according to a specific standard and/or may be configured to present a group of labels that are used with a particular computer program.

The input device with dynamical display of labels may eliminate or reduce the need for several input devices, such as several keyboards, and/or may eliminate or reduce the need for a user to remember short-cut combinations when using the input device. Thus, the time of adaption for a user to a new computer program may be reduced. Furthermore, the use of a computer mouse (or a similar device) may be reduced or eliminated since the use of drop down menus may not be needed or may be less needed by the user.

The input device and/or the first image displaying part may be configured to display the first image statically. This may provide a cheaper solution and/or an image display with a potentially improved image quality in terms of resolution. Furthermore, it may facilitate display of a hologram.

The at least one image displaying part may comprise at least one display, such as a liquid crystal display (LCD), a plasma display panel, a light-emitting diode (LED) display, an organic light-emitting diode (OLED) display, a liquid crystal on silicon (LCoS) display, or any other suitable display. Provision of at least one display may enable generation of image information for at least the first image.

The plurality of activation parts may be transparent or at least partly transparent (semitransparent) for allowing the at least one display to be viewed by the user through the at least one activation part.

The at least one display may comprise a light source for illumination the at least one display. Alternatively or in combination, the at least one display may depend on or may be configured to employ ambient light for being visible for the user.

The at least one display may be situated substantially parallel with the plurality of activation parts.

The at least one display may comprise a display for each activation part, such as a display integrated in each activation part.

The at least one display may comprise or be arranged in an integrated display that may have an individual display part for each image displaying part, e.g. for each activation part, e.g. for each key, e.g. for each cap part. Providing the input device with an integrated display may reduce complexity of production of the input device e.g. compared to provision of a keyboard with a display for each activation part.

The at least one display may comprise stacked displays, such as two stacked displays. Two stacked displays may provide display of auto-stereoscopic images as known in the art of displays. At least one of the two stacked displays may be at least partly transparent, such that at least part of the other display may be visible through the one display.

The at least one image displaying part may comprise at least one light scattering (diffusing) part including a first light scattering part for scattering incident light. The at least one light scattering part may comprise at least one diffuser including a first diffuser. The at least one light scattering part may comprise a polymer structure. The at least one light scattering part may enable imaging of the first image by having at least one light source, such as a display, a projector, or another light emitter, illuminating the at least one light scattering part (or parts thereof) with light for imaging.

The input device may comprise at least one light redirecting structure, such as a plurality of light redirecting structures, such as a plurality of mirrors or one or more micro-mirror devices, for redirecting light onto the at least one light scattering part.

The at least one light scattering part may be combined with the at least one display, such at an LCoS display. Thus, by means of rear-projection, e.g. by use of the at least one light redirecting structure, light from the at least one display may be projected on the at least one light scattering part for display of the first image. Provision of such a solution may reduce weight of the input device compared to the input device comprising another display.

The input device may comprise at least one optical element or at least one optical structure for focusing light onto the at least one light scattering part.

The at least one optical structure may be configured for projection from the at least one display on the at least one light scattering part. The at least one optical structure may be in form of a transparent polymer layer being provided in the optical path between the at least one display and the at least one light scattering part. The transparent polymer layer may form a plurality of lens shaped structures.

The at least one light scattering part may comprise a light scattering part for each image displaying part, e.g. for each key. The light scattering part may form part of the respective key and/or the respective cap parts.

The at least one light scattering part may be configured to at least partly transmit incident light or may be configured to at least partly reflect incident light.

By means of a light transmitting and scattering part, the input device may be configured for rear projection (at any convenient angle of incidence) of light from at least one light emitting part onto the at least one light scattering part.

By means of a light reflecting and scattering part, the input device may be configured for front projection (at any convenient angle of incidence) of light from at least one light emitting part onto the at least one light scattering part.

The input device may comprise at least one light emitting part including a first light emitting part for emitting light onto or towards the at least one light scattering part for displaying the first image. Provision of at least one light emitting part may enable generation of image information for at least the first image.

The at least one light emitting part may comprise at least one laser, such as at least one diode laser.

The at least one light emitting part may form part of an external device. Thus, a system according to the present invention may comprise the input device according to the present invention and an external light emitting device for emitting light on the at least one light scattering part for displaying the first image. The system may comprise a docking system for enabling that the position and orientation of the external light emitting device in relation to the input system is fixed for facilitating intentional projection of light from the external light emitting device onto the input device. Alternatively or in combination, the system may comprise a system for tracking the position and orientation of the external light emitting device in relation to the input device such that intentional projection of light from the external light emitting device onto the input device is enabled.

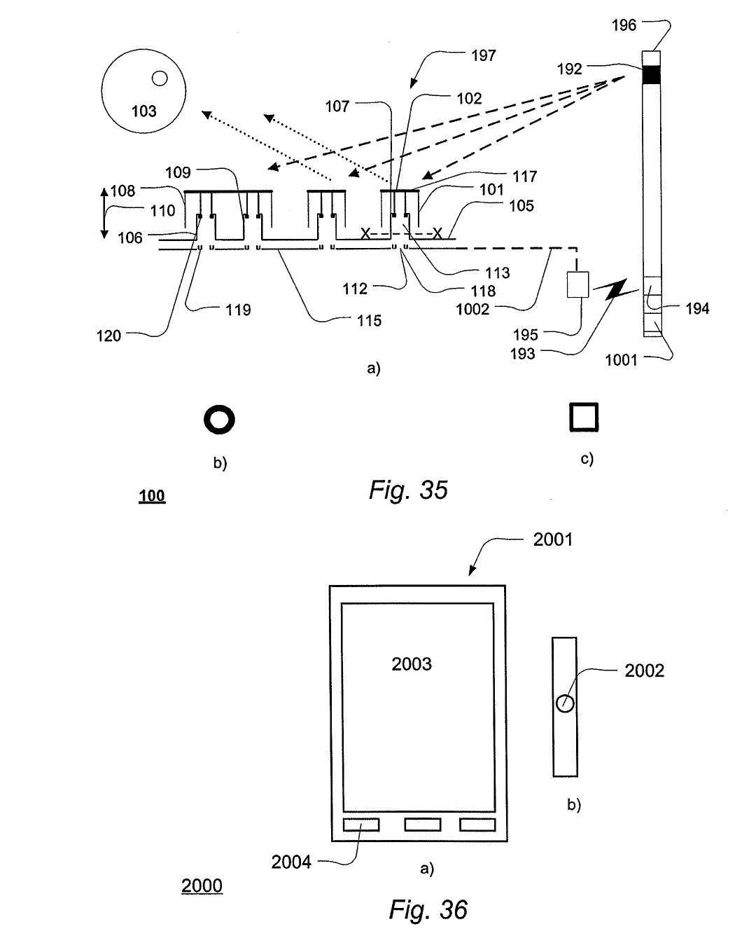

The external light emitting device may be integrated in a mobile communication device as disclosed in connection with any of FIGS. 35-44 or as disclosed in EP application number 10158664.2.

The at least one optical element or at least one optical structure may be configured for focusing light from the at least one light emitting part onto the at least one light scattering part.

The plurality of light redirecting structures may be configured for redirecting light from the at least one light emitting part onto the at least one light scattering part.

The input device may comprise a plurality of waveguide fibres. The plurality of waveguide fibres may have distal ends forming the at least one image displaying part. The waveguide fibres may be configured for redirecting light from at least one light emitting part for displaying the first image at the distal ends of the waveguide fibres or at some of the distal ends of the plurality of waveguide fibres.

The at least one image displaying part may be configured to displaying to the user the first image in form of a stereoscopic image, an auto-stereoscopic image, or a holographic image. Display of a stereoscopic image, an auto-stereoscopic image, or a holographic image is well known in the art of displaying images in 3D.

A holographic image may be a dynamic computer generated holographic image. Alternatively, the holographic image may be a static holographic image. A holographic image may for instance be provided by one or more holographic structures to be illuminated by the at least one light emitting part, such as a laser source, such as three laser sources, such as an RGB laser. A static holographic image may have a high image quality, e.g. in form of a high resolution.

The at least one image displaying part may comprise a lenticular lens and/or a parallax barrier. A lenticular lens and/or a parallax barrier may enable provision of an auto-stereoscopic image.

The at least one image displaying part may be configured to generate the auto-stereoscopic image by means of directional projection of light towards expected or detected positions of the eyes of the user. This is may be enabled by the provision of a lenticular lens and/or a parallax barrier. Alternatively or in combination, generation of an auto-stereoscopic image may be provided by directional backlight. Directional backlight may for instance be provided as disclosed in “IEEE Spectrum: “3D without four eyes”, pp. 48-53, December 2010”.

The expected positions of the eyes of the user may be between 30 and 70 cm from the centre of the plurality of activation parts.

The at least one image displaying part may comprise an encoder part enabling that light emitted by the at least one image displaying part is encoded, e.g. by polarization encoding or colour encoding, such that a stereoscopic first image is provided. A system according to the present invention may comprise the input device according to the present invention including the encoder part and an external decoding device corresponding to the encoder device. The external decoding device may for instance be a polarized or colour coded head-mountable device, such as glasses, for enabling a stereoscopic first image to be perceived in an intended manner by the user, i.e. to be perceived as a 3D image.

The input device according to the present invention may comprise a light-induced shape-memory polymer display screen as disclosed in US 2010/0295820. The input device may include a display screen having a topography-changing layer including a light-induced shape-memory polymer. The input device may further include an imaging engine configured to project visible light onto the display screen, where the visible light may be modulated at a pixel level to form a display image thereon, i.e. to form at least the first image. The display device may further include a topography-changing engine configured to project agitation light of an ultraviolet band towards the display screen, where the agitation light is modulated at a pixel level to selectively change a topography of the topography-changing layer. Thus, activations parts that enable depression may be provided.

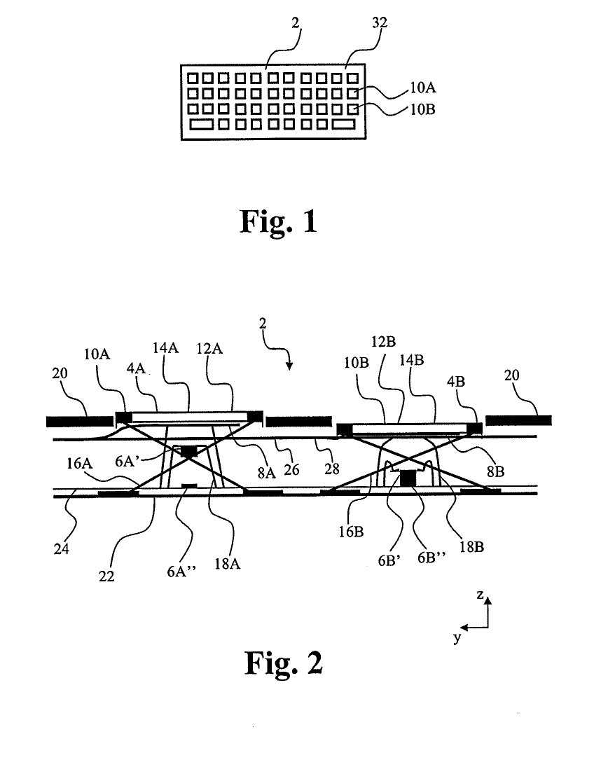

FIG. 1 schematically illustrates a top view an input device 2 according to the present invention. The input device 2 is a keyboard 32. The keyboard 32 includes a plurality of keys 10 including a first key 10A and a second key 10B. The input device is explained further in connection with FIGS. 2-4.

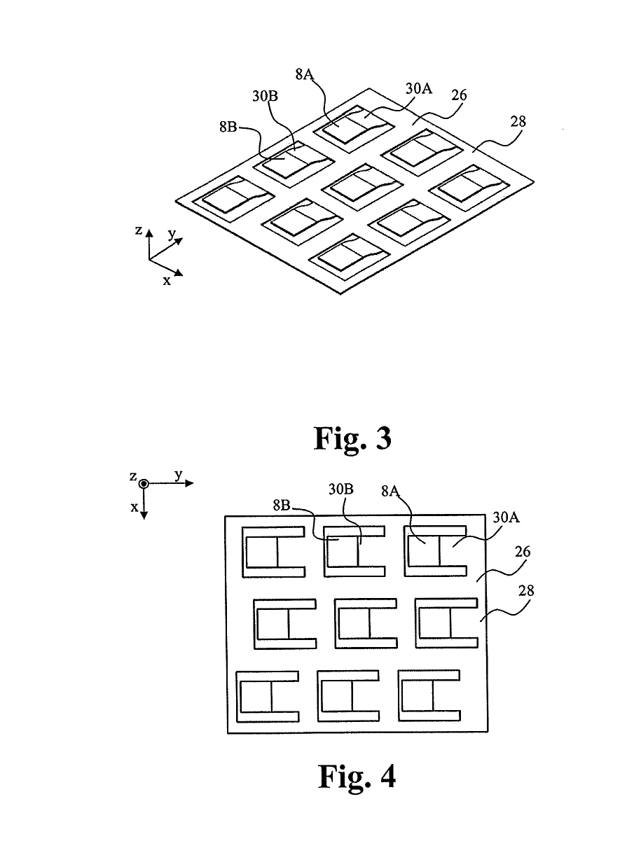

FIG. 2 schematically illustrates a side view of a part of an input device 2 according to the present invention. The viewing direction in relation to the display illustrated in FIGS. 3 and 4 is indicated by the respective xyz-coordinates of the FIGS. 2, 3, and 4, respectively. The input device 2 comprises a plurality of activation parts 4 including a first activation part 4A and a second activation part 4B. The input device 2 comprises a plurality of registration parts 6 including a first registration part 6A and a second registration part 6B. The input device 2 comprises a plurality of image displaying parts 8 including a first image displaying part 8A and a second image displaying part 8B.

The input device 2 is a keyboard with a plurality of keys 10 including a first key 10A and a second key 10B. The first key 10A has a first cap part 12A formed by the first activation part 4A and the second key 10B has a second cap part 12B formed by the second activation part 4B.

Each cap part 12 comprises a light transmitting part 14A, 14B allowing the image displaying part 8A, 8B to be seen through the light transmitting part 14A, 14B.

The input device 2 comprises a plurality of scissor-switches 16 including a first scissor-switch 16A and a second scissor-switch 16B.

The input device 2 comprises a plurality of domes 18 including a first dome 18A and a second dome 18B. The input device has a keyboard top 20 and a keyboard bottom 22 forming part of a housing for the keyboard.

The input device 2 furthermore comprises a printed circuit board (PCB) 24.

Each activation part 4 is configured for enabling depression of the activation part by a user. The input device 2 is configured such that depression of the activation part 4 provides tactile feedback to the user.

The input device comprises a scissor-switch 18 and a dome 16 for each activation part for generation of tactile feedback during depression of the respective activation part 4.

The first activation part 4A is illustrated in a non-depressed state and the second activation part 4B is illustrated in a depressed state. For depression of an activation part 4 a user may for instance use a finger, which however is not illustrated in FIG. 2.

The plurality of registration parts 6, 6A, 6B are configured for individual registration of depression of the activation parts 4, 4A, 4B. The first registration part 6A is configured for registration of depression of the first activation part 4A. The second registration part 6B is configured for registration of depression of the second activation part 4B.

When an activation 4 part is depressed to a certain level, a first part 6A′, 6B′ of the corresponding registration part 6 comes into contact with a corresponding second part 6A″, 6B″ of the registration part 6 on the PCB 24. The contact between a first part and a second part of a registration part 6 provides that the depression of the activation part 4 may be registered electronically via the PCB.

The travel distance of an activation part 4 from a position in rest to the position of registration is around 2 mm. In general, the travel distance may be selected in a range from 3 to 1 mm.

The first image displaying part 8A is configured for displaying a first image (not illustrated) to the user. The display of the first image is configured to be perceived by the user as a three-dimensional or a pseudo three-dimensional first image at the first activation part. The first image includes a first primary label (not illustrated) for the first activation part. A label may for instance include a letter and/or a symbol, such as a smiley symbol.

The second image displaying part 8B is configured for displaying a second image (not illustrated) to the user. The display of the second image is configured to be perceived by the user as a three-dimensional or a pseudo three-dimensional second image at the second activation part. The second image includes a second primary label (not illustrated) for the second activation part.

The plurality of image displaying parts 8A, 8B are arranged in an integrated display 26 (see FIGS. 2-4) comprising a display frame 28. Each image displaying part 8A, 8B is individually connected to the display frame 28 via a respective flexible region or arm 30, including a first region 30A for the first image displaying part 8A and a second region 30B for the second image displaying part 8B. The integrated display 26 comprises an organic light-emitting diode display, having an individual display part for each image displaying part 8. The plurality of imaging displaying parts 8 comprises an image displaying part 8 for each activation part 4.

In FIG. 2 of the input device 2, each image displaying part 8 comprises a parallax barrier, which enables the plurality of image displaying part to displaying to the user the first image in form of an auto-stereoscopic image and the second image in form of an auto-stereoscopic image as known in the art of 3D image displays. As an alternative or in combination with a parallax barrier, a lenticular lens may be provided with each image displaying part. For instance a lenticular lens may be integrated in an activation part or be situated at the surface of the image displaying part facing towards the activation part.

When an activation part 4 is being depressed, the corresponding display part 8 is depressed along with the activation part 4. The frame 28 of the integrated display 26 may substantially be at rest during the depression of the display part 8. This is enabled by the respective display arms or region 30 being flexible. The integrated display 26 is illustrated in more detail in FIGS. 3 and 4.

The first image displaying part 8A is configured to display the first image dynamically, i.e. e.g. the first image may be altered, e.g. during use of the input device and/or prior to use. The second image displaying part 8B is configured to display the second image dynamically.

FIG. 3 schematically illustrates a perspective view of the image displaying part 8 of an input device such as the input device of FIG. 1 or FIG. 2. The image displaying part 8 is arranged in an integrated display 26 comprising a display frame 28 and an individual display part for each of the plurality of activation parts. Each image displaying part 8A, 8B is individually connected to the display frame 28 via a respective flexible region or arm 30A, 30B.

FIG. 4 schematically illustrates a top view of the integrated display 26 illustrated in FIG. 3.

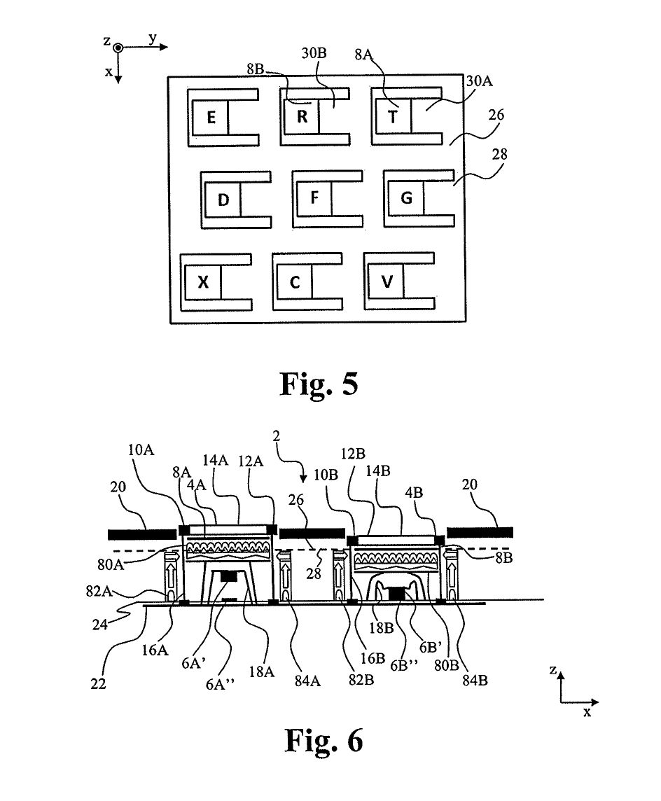

FIG. 5 schematically illustrates a top view of the integrated display 26 illustrated in FIGS. 3 and 4. Furthermore, FIG. 5 illustrates a primary label for each image displaying part. The primary labels are in the form of the capital letters: E, R, T, D, F, G, X, C, and V, and illustrates a part of a layout of a computer keyboard such as a computer keyboard with a Danish layout of labels.

FIG. 6 schematically illustrates a side view of an input device according to the present invention. The viewing direction in relation to the integrated display 26 illustrated in FIGS. 3 and 4 is indicated by the respective xyz-coordinates of the FIGS. 3, 4, and 6. The embodiment of FIG. 6 differs only from the embodiment illustrated in FIG. 2 in that for the embodiment of FIG. 6 the plurality of image displaying parts (image displaying parts 8 of the integrated display 26) must be configured for back-illumination (such by means of an LCD) and that the plurality of image displaying parts are configured to generate the auto-stereoscopic image(s) by means of directional projection of light towards expected positions of the eyes of the user. Thus, for parts that are found in both FIG. 2 and FIG. 6, reference is made to FIG. 2. For the embodiment of FIG. 6, the directional projection is provided by means of directional backlight provided by directional optical structures 80. The functioning of the directional optical structure 80 is disclosed in “IEEE Spectrum: “3D without four eyes”, pp. 48-53, December 2010”. A directional optical structure 80A, 80B is provided for each image displaying part. For the purpose of the present input device 2, each directional optical structure has a first length and a second length similar to the corresponding image displaying parts 8A, 8B. As explained in “IEEE Spectrum: “3D without four eyes”, pp. 48-53, December 2010”, light needs to be provided to the directional optical structure 80 from different directions at changing time intervals. This may be enabled in a plurality of ways, for example as illustrated in FIG. 6, where two light emitting parts 82A, 82B, 84A, 84B for each key are provided. The two light emitting parts includes a first 82 and a second 84 light emitting part for each directional optical structure. The direction of propagation of light is indicated by the block arrows. The input device 2 is configured such that when light is emitted by the first light emitting part 82, light is projected towards an expected position of a first eye and when light is emitted by the second light emitting part 84, light is projected towards an expected position of a second eye. The image of the respective display parts 8 then need to change between an image for the first eye and an image for the second eye, respectively and coordinated with the first and second light emitting part. The images (and direction of light propagation) may for instance change at a rate of 200 Hz-50 Hz.

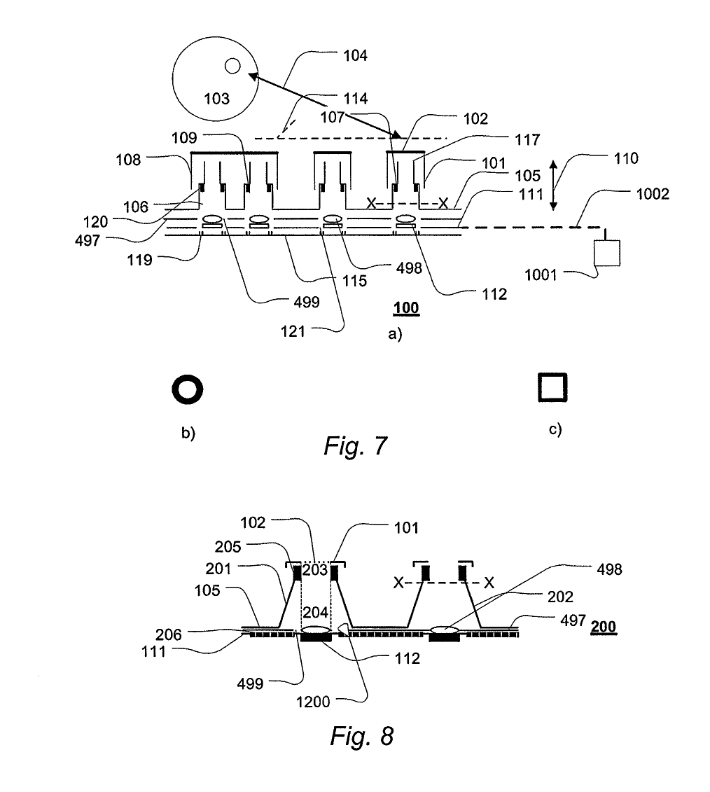

In FIGS. 7-34 are disclosed embodiments of input devices (dynamic display keyboards). The embodiments are configured for displaying at least the first image dynamically.

Furthermore, all embodiments as illustrated in any of FIGS. 7-44 are configured for displaying at least the first image as a 3D image.

For the embodiments illustrated in any of FIGS. 7-34, displaying at least the first image as a 3D image may for instance be enabled by means of a parallax barrier and/or a lenticular lens and/or a directional optical structure as disclosed in “IEEE Spectrum: “3D without four eyes”, pp. 48-53, December 2010” and/or by comprising stacked displays and/or by any of the means mentioned in the present description. For the embodiments illustrated in any of FIGS. 7-34 the at least one image displaying part may be configured to displaying to the user the first image in form of a stereoscopic image, or an auto-stereoscopic image.

For the embodiments illustrated in any of FIGS. 35-44, display in 3D may be enabled by means of displaying a stereoscopic image, to be view by means of an appropriate decoder, such as polarized glasses. For the embodiments illustrated in any of FIGS. 35-44 the at least one image displaying part may be configured to displaying to the user the first image in form of an auto-stereoscopic image.

With reference to any embodiment illustrated in any of FIGS. 7-44, the input device may comprise or be composed of a dynamic display keyboard 100, 200, 400, 701, 800.

With reference to any embodiment illustrated in any of FIGS. 7-44, an activation part and/or the first cap part may comprise a key element 101, 108 and/or an elevated element 106 such as dome elements 106, 107, 109, 201, 202 capable of providing a tactile feedback as described above and/or may be included in a mat comprising a plurality of elevated elements.

With reference to any embodiment illustrated in any of FIGS. 7-44, the at least one registration part may comprise or be composed of a plurality of pads 119 for determining whether a key element 101, 108 has been pressed and/or a rod 1102 that may be made of a conductive material such as iron doped rubber or the like and/or a photo-detector 1200.

With reference to any embodiment illustrated in any of FIGS. 7-34, the at least one image displaying part may comprise or be composed of at least one display unit 111, 911, 904 and/or at least one transmitting part 102, such as at least one diffuse-transmission part or layer.

FIG. 7 a) shows an embodiment of a dynamic display keyboard 100 (input device). The dynamic display keyboard comprises a plurality of key elements 101 (activation parts) e.g. a plurality of alpha-numeric keys. Each of the key elements 101 comprises a transmitting part 102 capable of transmitting at least a part of light incident on the transmitting part 102.

In an embodiment, the transmitting part 102 comprises a diffuse-transmission layer. In the above and below, a diffuse-transmission layer is a transmitting layer transmitting electromagnetic radiation in all directions. In an embodiment, the electromagnetic radiation transmitted in all directions may be incident electromagnetic radiation e.g. from a group of pixels 112 included in a light generating layer 111 such as a LCD display or the like. In an additional embodiment, the incident electromagnetic radiation is visible to a human being i.e. in the wavelength range from approximately 380 nm (violet light) to approximately 750 nm (red light).

The transmitting parts 102 may be positioned at the top of the key elements 101 as indicated in FIG. 7 a). Thereby, light incident on the transmitting part 102 from a light generating device, such as a group of pixels 112 in a light generating device 111 (such as a flat-panel display e.g. OLED or LCD), may reach a user 103 e.g. via light path 104. The transmitting parts 102 may be connected to the key element 101 via glue, vulcanization, or the like.

The dynamic display keyboard 100 may further comprise a mat 105 made of an elastic and flexible material such as rubber. The mat 105 may comprise a plurality of elevated elements such as dome elements 106, 107, 109 capable of providing a tactile feedback. The dome elements 106, 107, 109 may be made in the same material as the mat 105. The mat 105 comprising the dome elements 106, 107, 109 may in one embodiment be cast in one piece. The dome elements 106, 107, 109 may be open in both ends 117, 118 i.e. the end facing the transmitting part 102 and the end facing the group of pixels 117. Further, the dome elements 106, 107, 109 may be hollow.

The dome elements 106, 107, 109 may be hollow in order to reduce absorption of light in them. Alternatively, the dome elements 106, 107, 109 may be filled with a transparent and elastic and flexible material such as a transparent polymer or the like. The dome elements 106, 107, 109 may further be open in both ends 117, 118. Thereby, the dome elements 106, 107, 109 enable passage of light from at least a group of pixels 112 from the light generating device 111 to the transmitting part 102.

In an embodiment, the inner surface of the dome elements 106, 107, 109 may be coated with a reflecting material such as e.g. a thin metal layer such as aluminium.

Each key element 101 is physically coupled to at least one dome element 106 as disclosed below. As seen in FIG. 7 a), key element 101 is in physically connected to one dome element 107, and key element 108 is physically connected to two dome element 106 and 109. The number of dome elements 106, 107, 109 physically connected to a key element 101, 108 may depend on the size of the key element such that a large key (e.g. a space key) may be connected to a plurality of dome elements and a small key (e.g. a character key) may be connected to a single dome element.

In a computer keyboard, for example, a SHIFT key may be physically connected to two dome elements, an alpha-numeric key may be physically connected to one dome element, and the spacebar may be physically connected to four dome elements.

The terms physically coupled and physically connected are to be understood as the key element may be resting on the dome element and/or it may be glued or vulcanized to the dome element and/or welded to the dome element.

In an embodiment, the dome elements 106, 107, 109 provides control of the dimensions in which the key elements 101, 108 may move in. The dome elements 106, 107, 109 may in an embodiment restrict the direction in which the key elements 101, 108 may move. In an embodiment, the direction to which the key elements may move may be the direction 110 perpendicular to the rubber mat 105 or substantially perpendicular to the rubber mat 105 e.g. 90 degrees+/−5 degrees.

In order to have the dome element deform, an external force provided by a user pressing the associated key element, is required. The dome elements may be made of a soft plastic or rubber or any other material capable of deforming along the direction of movement 110 when an external force having a component in the direction of movement 110 is applied to the key element 101. In an embodiment, the dome element 106 may be such as to require a threshold force in the direction of movement 110 before deforming thereby providing a tactile response to a user applying a force to the key element 101 and making the dome element able to sustain the weight of the key element 101 without any substantial deformation in the direction of movement 110 of the key element when an external force is not applied.

Thereby, the dome element 106, 107, 109 is able to provide a tactile feedback in response to a user action e.g. a user pressing the key element.

The key element 101 may be made of a material harder than the dome element. For example, the key element 101 may be made of melamine resin.

FIG. 7 b) shows a circular cross-sectional view along the X-X axis of a dome element 106, 107, 109.

FIG. 7 c) shows a square cross-sectional view along the X_X axis of a dome element 106, 107, 109.

The dynamic display keyboard 100 may further comprise at least one display unit 111. The display unit 111 is adapted to provide light to the plurality of transmitting parts 102. The display unit 111 may comprise a LCD or OLED in which a pixel or a group of pixels 112 of the display are assigned to a key element 101.

In an embodiment of the keyboard of FIG. 7, the keyboard 100 further comprises a transparent layer 497 of the same size as the display unit 111 and the transparent layer 497 comprising at least one transparent lens-formed element 498. The lens-formed element 498 may be made of a transparent polymer.

In an embodiment, the transparent layer 497 comprises a plurality of transparent lens-formed elements 498. The transparent layer 497 may comprise a lens-formed element 498 for each group of pixels 112 associated with a key element.

In an embodiment, the transparent layer 497 comprising the lens-formed elements 498 are positioned between the mat 105 and the display unit 111 and such that a lens-formed element 498 is positioned under the respective key element 101 to which the lens-formed element is associated and above the group of pixels 112 associated with the respective key element 101.

The transparent layer 497 may be placed directly on the display unit 111. Additionally, the transparent layer 497 may be glued or otherwise fixed to the display unit 111.

The lens-formed elements 498 are adapted to focus the light emitted from the display unit 111 onto the transmitting part 102 of the corresponding key element 101.

In an embodiment, the lens-formed elements 498 may be biconvex lens-formed elements.

In an embodiment, the lens-formed layers 498 may comprise a Fresnel-lens.

As seen in FIG. 7 a), the elastic and flexible mat 105 is positioned above the transparent layer 497 and thus between the plurality of key elements 101, 108 and the transparent layer 497.

In an embodiment, the dynamic display keyboard 100 may additionally comprise a printed circuit board (PCB) 115 comprising a plurality of pads 119 for determining whether a key element 101, 108 has been pressed. The pads may in an embodiment be made of carbon e.g. an electrically conducting carbon.

In an embodiment, the PCB is positioned below the display unit 111 and in this embodiment, holes/openings 121 in the display unit 111 and holes/openings 403 in the transparent layer 497 are made such that when a key element 101 is depressed, a conductive element 120 connected to the dome element 107 associated with the key element 101 passes through the opening 403 in the transparent layer 497 and through the opening 121 in the display unit 111 in the light generating layer 111 and is brought into contact with the first and second pad parts thereby short circuiting the first and second pad parts of at least one pad 119, thereby enabling detection of the depressed key element 101.

In an alternative embodiment, the PCB is made in a transparent material such as a transparent polymer and the PCB is positioned between the display unit 111 and the transparent layer 497. In this embodiment, holes/openings 403 are made in the transparent layer 497 such that when a key element 101 is depressed, a conductive element 120 connected to the dome element 107 associated with the key element 101 passes through the opening 403 in the transparent layer 497 and is brought into contact with the first and second pad parts thereby short circuiting the first and second pad parts of at least one pad 119, thereby enabling detection of the depressed key element 101.

In an embodiment, a processing unit 1001 may be communicatively coupled to the light generating layer 111 via a wireless and/or wired communication link such as Bluetooth or cable. The processing unit 1001 may determine which characters are to be displayed on which key elements 101 by providing a control signal to the respective group of pixels 112 under the key elements 102. In an embodiment, the processing device 1001 further comprises a power providing unit such as a connection to a power grid and/or an battery.

In an embodiment, the PCB circuit is communicatively coupled to the processing unit 1001 via a wireless and/or wired communication link such as Bluetooth or cable. The value of a detected depressed key element 101 may be transmitted from the PCB circuit to the processing unit 1001 for further processing.

In an embodiment, anyone of the below embodiments of FIGS. 8 and 10 and 12 and 13 and 14 may be communicatively coupled to a processing device 1001 as disclosed above.

FIG. 8 shows an embodiment 200 of a dynamic display keyboard. As in the above embodiment 100, the dynamic display keyboard 200 comprises a key element 101 comprising a transparent part 102. The transparent part 102 may be connected to the key element 201 by gluing, vulcanization, welding or the like.

Further, as described above, the dynamic display keyboard 200 further comprises a mat 105 made of an elastic and flexible material such as rubber. The rubber mat 105 may comprise a plurality of elevated elements such as dome elements 201, 202 capable of providing a tactile feedback as described above.

Additionally, as described above, the dynamic display keyboard 200 may further comprise a transparent layer 497 comprising a plurality of transparent lens-formed elements 498.

The dome elements 201, 202 of FIG. 8 may comprise a cross-sectional form being trapezium shaped in the plane illustrated in FIG. 8. Further, the cross sectional form of the dome elements 201, 202 may be square-shaped along the X-X plane. As above, the rubber mat 105 are open in both ends 203, 204 such as to enable light to pass the dome element from a light generating device 111 to the transparent part 102.

In this embodiment, the dynamic display keyboard 200 may comprise light generating device 111 in the form of a touch sensitive display utilizing capacitive detection. An electrically insulating layer 206 such as a plastic or rubber may be deposited on the light generating layer with openings corresponding to the groups of pixels 112 defining the values of the key elements 101 and fixators 205 disclosed below. The electrically insulating layer may thus be positioned between the light generating device 111 and the mat 105.

In an embodiment, the electrically insulating layer 206 may be transparent.

In an embodiment, the electrically insulating layer 206 may be comprised in the transparent layer 497 comprising a plurality of transparent lens-formed elements 498 such that the layer 497 constitutes both the isolating layer and the layer comprising the dome element. In this embodiment, the transparent layer 497 comprises openings 499 adapted to enable passage of the fixators 205.

In the embodiment of FIG. 8, the rubber mat 105 further comprises fixators 205 to which the key elements 101 may be fixated e.g. by gluing, vulcanization, welding or the like. The distance between to opposing inner sides of the fixators 205 may correspond to size of the transparent part 102 in the respective dimensions of the plane containing the transparent part 102. The fixators 205 may be made of a hard plastic or rubber material such as to provide a stable platform on which the key element 101 may be placed.

In an embodiment, the fixators 205 are able to conduct an electric current. For example, the hard plastic or rubber may be doped with a metallic powder such as iron or the like. Alternatively or additionally, the fixators 205 may contain an electric wire providing an electrically closed loop.

In an embodiment, the light generating device 111 is a touch sensitive display with capacitive detection.

In an embodiment, the fixators 205 are separate entities glued or vulcanized or welded to the dome elements 201.

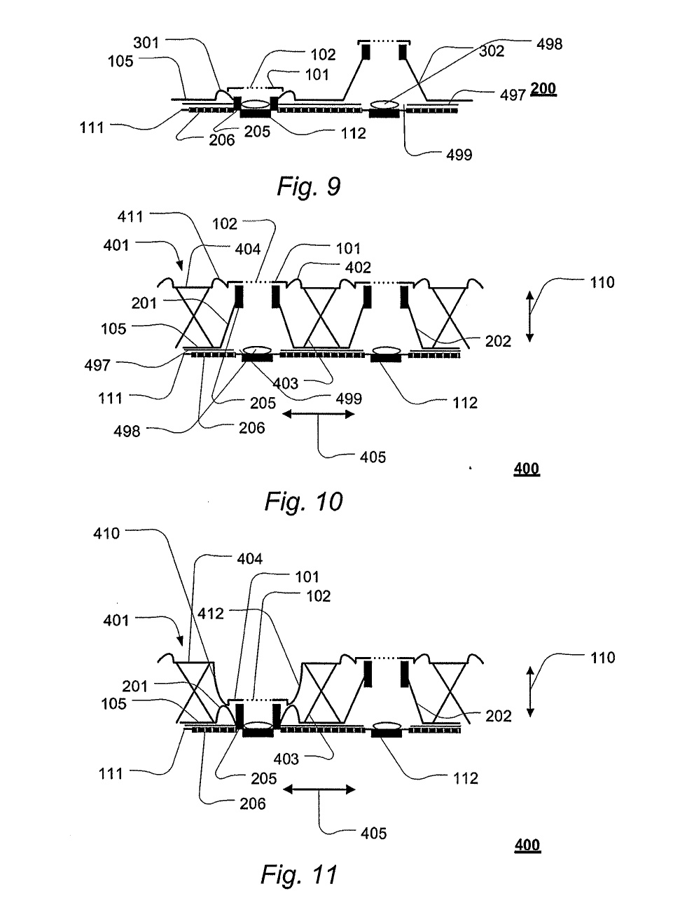

FIG. 9 shows an embodiment in which a key element 101 of the dynamic display keyboard 200 comprising electrically conducting fixators is in a depressed state. In this embodiment, the light generating device 111 is a touch sensitive display with capacitive detection. Thereby, when a key element 101 is depressed, the electrically conductive fixators 205 of the key element 101 is brought into contact with the electric field of the capacitive detection and thereby, the touch sensitive display may detect the depressed key element 101. Thereby, the dynamic display keyboard 200 may be used in combination with a touch sensitive display which may provide the value of the key elements 101 by displaying respective key values under respective key elements 101 and the touch display may further provide detection of a depressed key element 101 by detecting changes to the electric field provided by the capacitive detection. 301 and 302 denotes depressed/flexed dome elements 201, 202. The detected depressed key value may be transmitted to the processing unit 1001 for further processing.

FIG. 10 shows an embodiment 400 of the dynamic display keyboard 200 further comprising a layer 401 in which the key elements 101 are included.

The layer 401 may be comprise a collar/ridge 402. The collar/ridge 402 is made of an elastic and flexible material such as rubber. Additionally, the layer 401 may comprise a rigid part 404 made of a hard and non-flexible plastic.

Between the rigid part 404 and the mat 105 (in the direction 110), supporting elements 403 may be positioned i.e. between the dome elements 201 of the mat 105 (in the direction 406). The supporting elements 403 supports the layer 401. The supporting elements 403 may be glued or vulcanized or welded to the rigid part 404 and the mat 105.

The key elements 101 comprises a transparent part 102 i.e. a transparent window. The key elements 101 may be glued or vulcanized or welded to the collar/ridge 402.

In an embodiment, the collar/ridge 402 is made of a transparent elastic and flexible material.

In an embodiment, the dynamic display keyboard 400 further comprises an electrically insulating layer 206 such as a plastic or rubber deposited on the light generating layer 111 with openings corresponding to the groups of pixels 112 defining the values of the key elements 101 and fixators 205 disclosed above.

Additionally, as described above, the dynamic display keyboard 200 may further comprise a transparent layer 497 comprising a plurality of transparent lens-formed elements 498.

In an embodiment, the electrically insulating layer 206 may be transparent.

In an embodiment, the electrically insulating layer 206 may be comprised in the transparent layer 497 comprising a plurality of transparent lens-formed elements 498 such that the layer 497 constitutes both the isolating layer and the layer comprising the dome element. In this embodiment, the transparent layer 497 comprises openings 499 adapted to enable passage of the fixators 205.

In an embodiment, the light generating layer 111 of the dynamic display keyboard 400 is a touch sensitive display with capacitive detection.

In an embodiment, the height from the top of the light generating layer 111 and to the top of the transparent window 102 is chosen in the range from 2.5 mm to 3.5 mm. In an embodiment, the height from the top of the light generating layer 111 and to the top of the transparent window 102 is chosen in the range from 2 mm to 3 mm. In an embodiment, the height from the top of the light generating layer 111 and to the top of the transparent window 102 is chosen to be 3 mm. Thereby, a large angle of view of the key values associated with a key element for a user is provided by the dynamic display keyboard.

FIG. 11 shows an embodiment in which a key element 101 of the dynamic display keyboard 400 is in a depressed state. In the depressed state, the dome element 201 of the depressed key element 101 and the collar/ridge 402 of the depressed key 101 are flexing to provide the tactile feedback of the key element 101.

In an embodiment, the light generating device 111 is a touch sensitive display with capacitive detection. Thereby, when a key element 101 is depressed, the electrically conductive fixators 205 of the key element 101 is brought into contact with the electric field of the capacitive detection and thereby, the touch sensitive display may detect the depressed key element 101. Thereby, the dynamic display keyboard 400 may be used in combination with a touch sensitive display which may provide the value of the key elements 101 by displaying respective key values under respective key elements 101 and the touch display may further provide detection of a depressed key element 101 by detecting changes to the electric field provided by the capacitive detection. 301 and 302 denotes depressed/flexed dome elements 201, 202 and 410 and 412 denotes depressed/flexed collar/ridge elements 402 and 411.

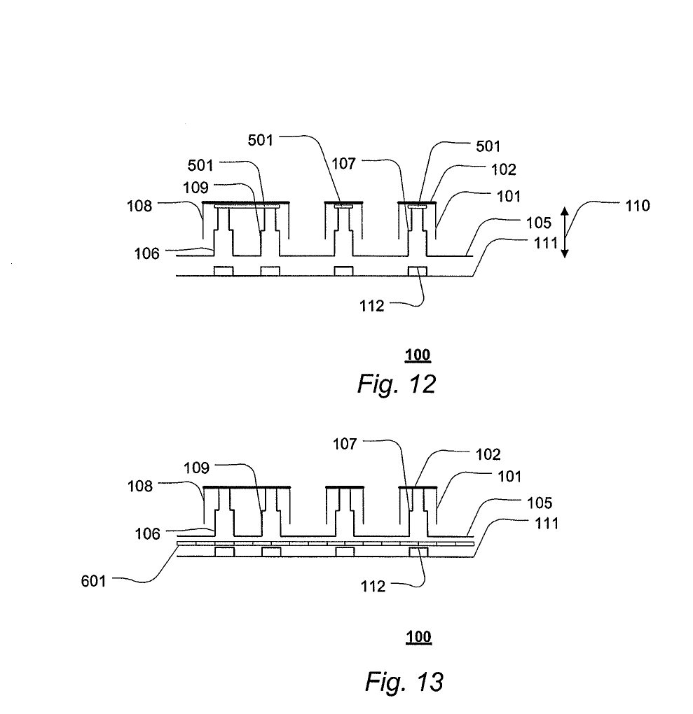

FIG. 12 shows an embodiment of the keyboard of FIG. 7. The embodiment of FIG. 12 may comprise all the technical features of FIGS. 7 and/or 2 and/or 4. Instead of the transparent layer 401, the embodiment of FIG. 11 may comprise a transparent lens-formed element 501 in each of the key elements 101. As in FIG. 7, the transmitting part 102 comprises a diffuse-light transmitting layer.

The transparent lens-formed element 501 may be glued to the transmitting part 102 or pressed against the transmitting part 102 by the dome element 107.

The transparent lens-formed element 501 may be planoconvex such as to enable light from the group of pixels 112 to be focussed onto the transmitting part 102 by the transparent lens-formed element 501. In an embodiment, the transparent lens-formed element 501 may be adapted to focus the light incident from the group of pixels 112 onto the top of the transmitting part 102.

Thereby is achieved that the key-information associated with the key element 101 is projected onto the top of the key element 101. Thereby, the angle of view of the key information of the key element 101 is increased. The lens-formed element 501 may be such as to ensure that the image projected to the top of the key element 101 is in focus when the key element is in its un-pressed position.

In an embodiment, the transparent lens-formed layer 501 may comprise a Fresnel-lens.

FIG. 13 shows an embodiment of the keyboard of FIG. 7 further comprising a lenslet-array 601 for focussing the light emitted by the display unit 111 onto the respective transmitting parts 102 of the key elements 101. The embodiment of FIG. 13 may comprise all the technical features of FIGS. 7 and/or 8 and/or 10. In this embodiment, the transmitting part 102 comprises a diffuse-light transmitting layer such as a diffuse polymer. The lenslet-array 601 may be contained in a polymer disc or rectangle covering the area of the display unit 111. The lenslet-array 601 may be positioned between the display unit 111 and the elastic and flexible mat 105.

The lenslet-array 601 may be such as to ensure that the image projected to the top of the key element 101 is in focus when the key element is in its un-pressed position.

In an embodiment, the lenslet array 601 may comprise an integral lens array (also known as a fly-eye lens array).

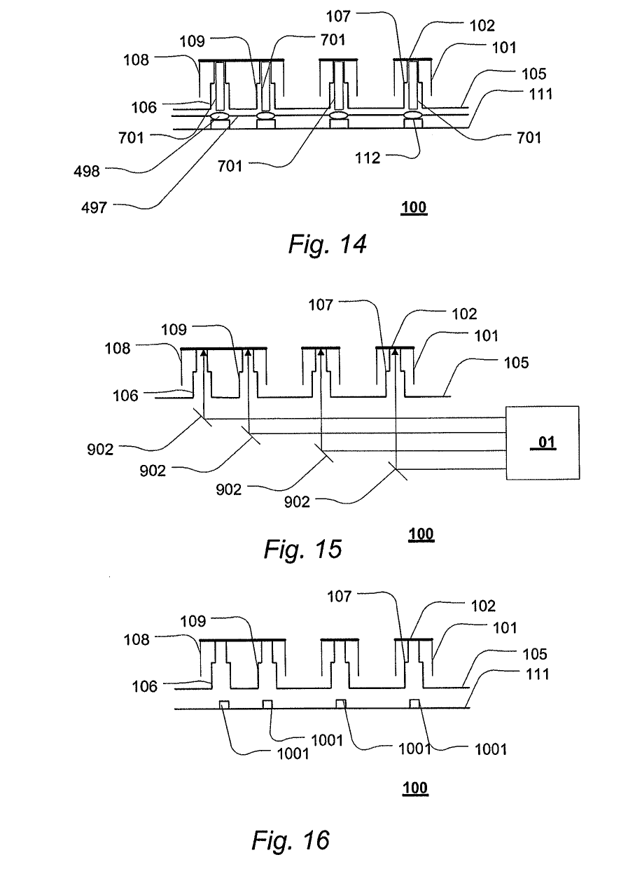

FIG. 14 shows an embodiment of the keyboard of FIG. 7 further comprising a fiber-optic array comprising a plurality of optical fibers 701, wherein a first end of an optical fiber is optically coupled to the group of pixels corresponding to a key element 101 via a lens element 498 of a transparent layer 497, and a second end of the optical fiber is optically coupled to the transmitting part 102 of the respective key element 101. An optical coupling may be exemplified by an optical transparent glue or the like. In this embodiment, the transmitting part 102 comprises a diffuse-light transmitting layer such as a diffuse polymer.

In an embodiment, the plurality of fibers are positioned between the transmitting part 102 and the layer 497 such that each lens element 498 thus ensures coupling of light from a respective group of pixels to a associated optical fiber 701. Each optical fiber 701 may thus ensure guidance of light from the lens element 498 associated with a key element 101 to the transmitting part 102 of the key element 101.

In an alternative embodiment, the plurality of fibers are positioned between the transmitting part 102 and elevated elements such that a respective group of pixels couples light directly into an associated optical fiber 701. The optical fiber 701 couples the light onto the transmitting part 102 via the lens 498. Each optical fiber 701 may thus ensure guidance of light from the group of pixels 112 to the respective lens element 498 and from there onto the transmitting part 102 of the key element 101.

FIG. 15 shows an embodiment of the keyboard of FIG. 7 wherein the display unit 111 comprises light-generating unit 901 such as a digital micro-mirror device (DMD) or a liquid crystal on silicon unit (LCoS). Further, the keyboard comprises at least one mirror 902 for each key element 101 contained in the keyboard 100. Additionally, the embodiment of FIG. 15 may comprise the mat 105 and the key elements 101 comprising a transmitting part 102.

In this embodiment, the transmitting part 102 comprises a diffuse-light transmitting layer such as a diffuse polymer.

Thereby, the light-generating unit 901 is adapted to provide light to each of the key elements 101 by illuminating the respective mirrors 902 which subsequently reflect the incident light onto the diffuse-light transmitting layer of the key elements 101.

By using a DMD or a LCoS, the weight of the keyboard 101 may be reduced.

FIG. 16 shows an embodiment of the keyboard of FIG. 7 comprising a holographic laser projection (HLP) unit. The HLP may contain a class 1 laser product 1001 i.e. an eye-safe RGB laser-diode in the display unit 111. Further, the HLP may contain a holographic generating layer in the transmitting part 102, which holographic generating layer comprises a diffractive structure and provides the alpha-numeric value of the associated key element 101 when illuminated by the class 1 laser product 1001. In an embodiment, the holographic generating layer may be communicatively coupled to the processing unit 1001 via a wireless and/or wired link such as a Bluetooth link or an electrical wire. Thereby, the diffractive structure of each key element 101 may be changed by the processing unit 1001 and thereby provide a dynamic display keyboard.

Additionally, the embodiment of FIG. 16 may comprise the mat 105 and the key elements 101 comprising a transmitting part 102.

In an embodiment, the keyboard may be included in a computer system via a wired and/or wireless communication link such as an electric cable and/or a Bluetooth link. In this embodiment, the keyboard may comprise a short-range radio receiver and transmitter (e.g. a Bluetooth transmitter and receiver) and the computer system may comprise a similar short-range radio receiver and transmitter. Additionally or alternatively, the keyboard and the computer system may comprise a socket for an electric wire via which the computer system and the keyboard may be connected via an electric wire.

In an embodiment, the dynamic display keyboard of FIG. 7 a) or 8 or 10 or 12 may further comprise a photo-detector 1200 in proximity to each group of pixels associated with a respective key element 101. The photo-detector may be communicatively coupled via Bluetooth or a wire to the processing unit 1001. The photo-detector may detect the intensity of light reaching the photo-detector 1200. When a key-element is depressed, the intensity of light detected by the photo-detector decreases due to 1) the object (e.g. a finger) placed on the key element 101 and thus also the transmitting part 102 by the user and 2) the depressed key element may further block for light reaching the photo-detector 1200. Thus, the intensity of light detected by the photo-detector may be used to determine when a key element is depressed. For example, the processing unit may receive intensity-measurements from the photo-detectors each millisecond, and if one or more of the intensities from the respective photo-detectors falls below a predetermined threshold value, then the processing unit 1001 may determine that the one or more key elements 101 associated with the photo-detectors measuring a decrease in intensity, have been depressed.

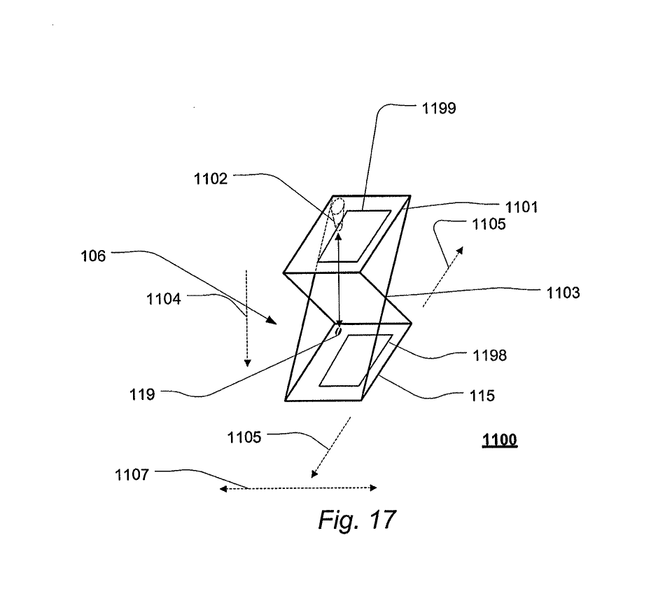

FIG. 17 shows an embodiment of a key 1100 in a dynamic keyboard comprising a scissor-switch.

The key 1100 comprises a scissor element 106. The scissor element 106 may comprise a closed top 1101 under which a rod 1102 may be attached in a corner by glue, vulcanization, welding or the like. The rod 1102 may be made of a conductive material such as iron doped rubber or the like. The scissor element 106 may further comprise two X-formed structures which may be collapsible around a pivotal point 1103 like an opening scissor. Further, the closed top 1101 may comprise a diffuse transmission part 1199 e.g. a diffuse transmission window. The closed top 1101 may act as a key element which may be depressed by a user. The key 1100 may further comprise a PCB 115 comprising a pad arrangement 119 in a corner below the rod 1102.

The key 1100 may further comprise an opening or a transparent window 1198 in the PCB 115. The opening or transparent window 1198 may be adapted to transmit light from a group of pixels (not shown) to the diffuse transmission part 1199.

In case of an opening 1198, the light from the group of pixels may be guided through a transparent lens-formed element (not shown) focussing the light onto the diffuse transmission part 1198 through the opening 1198.

In case of a transparent window 1198, the light from the group of pixels may be guided through a transparent lens-formed element (not shown) focussing the light onto the diffuse transmission part 1198 before passing the window 1198 or alternatively, the transparent window may comprise the transparent lens-formed element.

When a force 1104 is applied to the closed top 1101, the bottom part of the X-structures slides on a rail or track along the direction 1105 thereby reducing the height of the scissor element 106. At a point, the rod 1102 will come into physical contact with the pad arrangement 119 of the PCB 115, whereby electrical contact is made between the two pad parts and the key 1100 may be detected as having been depressed.

The embodiment 1100 may be used in a low profile type keyboard such as known from laptops and the like.

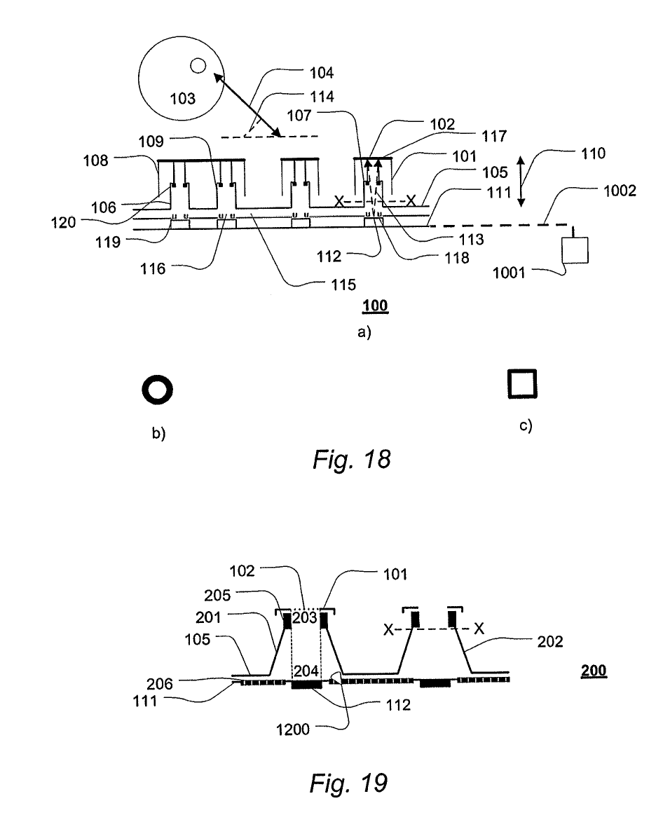

FIG. 18a shows an embodiment of a dynamic display keyboard 100. The dynamic display keyboard comprises a plurality of key elements 101 e.g. a plurality of alpha-numeric keys. Each of the key elements 101 comprises a transmitting part 102 capable of transmitting at least a part of light incident on the transmitting part 102.

In an embodiment, the transmitting part 102 may be made of a transparent polymer or of silica glass or the like i.e. a material having a high transmittance of the incident light. In an additional embodiment, the transmitting part 102 is made of a material having a high transmittance of incident light visible to a human being i.e. in the wavelength range from approximately 380 nm (violet light) to 750 nm (red light).

The transmitting parts 102 may be positioned at the top of the key elements 101 as indicated in FIG. 18a. Thereby, light incident on the transmitting part 102 from a light generating device, such as a group of pixels 112 in a light generating device 111 (such as a flat-panel display e.g. OLED or LCD), may reach a user 103 e.g. via light path 104. The transmitting parts 102 may be fastened to the key element 101 via glue, vulcanization, or the like.

The dynamic display keyboard 100 may further comprise a mat 105 made of an elastic and flexible material such as rubber. The rubber mat 105 may comprise a plurality of elevated elements such as dome elements 106, 107, 109 capable of providing a tactile feedback. The dome elements 106, 107, 109 may be made in the same material as the mat 105. The mat 105 comprising the dome elements 106, 107, 109 may in one embodiment be cast in one piece. The dome elements 106, 107, 109 are open in both ends 117, 118 and hollow such as to enable passage of light from at least a group of pixels 112 of the light generating device 111 to the transmitting part 102.

The dome elements 106, 107, 109 may be hollow in order to reduce absorption of light in them. Alternatively, the dome elements 106, 107, 109 may be filled with a transparent and elastic and flexible material such as a transparent polymer or the like. The dome elements 106, 107, 109 may further be open in both ends 117, 118. Thereby, the dome elements 106, 107, 109 enable passage of light from at least a group of pixels 112 from the light generating device 111 to the transmitting part 102.

In an embodiment, the inner surface of the dome elements 106, 107, 109 may be coated with a reflecting material such as e.g. a thin metal layer such as aluminium.

Each key element 101 is fixedly connected to at least one dome element 106. As seen in FIG. 18a, key element 101 is fixedly connected to one dome element 107, and key element 108 is fixedly connected to two dome element 106 and 109. The number of dome elements 106, 107, 109 fixedly connected to a key element 101, 108 may depend on the size of the key element such that a large key (e.g. a space key) may be connected to a plurality of dome elements and a small key (e.g. a character key) may be connected to a single dome element.

In a computer keyboard, for example, a SHIFT key may be fixedly connected to two dome elements, an alpha-numeric key may be fixedly connected to one dome element, and the spacebar may be fixedly connected to four dome elements.

The term fixedly connected is to be understood as the key element may be resting on the dome element and/or it may be glued or vulcanized to the dome element and/or welded to the dome element.

In an embodiment, the dome elements 106, 107, 109 provides control of the dimensions in which the key elements 101, 108 may move in. The dome elements 106, 107, 109 may in an embodiment restrict the direction in which the key elements 101, 108 may move. In an embodiment, the direction to which the key elements may move may be the direction 110 perpendicular to the rubber mat 105 or substantially perpendicular to the rubber mat 105 e.g. 90 degrees+/−5 degrees.

In order to have the dome element deform, an external force provided by a user pressing the associated key element, is required. The dome elements may be made of a soft plastic or rubber or any other material capable of deforming along the direction of movement 110 when an external force having a component in the direction of movement 110 is applied to the key element 101. In an embodiment, the dome element 106 may be such as to require a threshold force in the direction of movement 110 before deforming thereby providing a tactile response to a user applying a force to the key element 101 and making the dome element able to sustain the weight of the key element 101 without any substantial deformation in the direction of movement 110 of the key element when an external force is not applied.

Thereby, the dome element 106, 107, 109 is able to provide a tactile feedback in response to a user action e.g. a user pressing the key element.

The key element 101 may be made of a material harder than the dome element. For example, the key element 101 may be made of melamine resin.

FIG. 18b shows a circular cross-sectional view along the X-X axis of a dome element 106, 107, 109. The dome element 106, 107, 109 may be open in both ends i.e. the end 117 facing the key element 101, 109 and the end 118 facing the rubber mat 105.

The dynamic display keyboard 100 may further comprise at least one display unit 111. The display unit 111 is adapted to provide light to the plurality of transmitting parts 102. The display unit 111 may comprise a LCD or OLED in which a pixel or a group of pixels of the display are assigned to a key element 101. As seen in FIG. 18a, a group of pixels are positioned under the key element 101 comprising the transmitting part 102, and therefore light 113 emitted by the group of pixels 112 may pass the dome element 107 to reach the transmitting part 102. The group of pixels may comprise one or more pixels in one or two directions i.e. a linear or planar arrangement of pixels may be comprised in the group of pixels 112.

As seen in FIG. 18b, the elastic and flexible mat is positioned between the display unit 111 and the plurality of key elements 101, 108.

In an embodiment, the maximal height from the top of a transmitting part 102 of a key element 101 to the top of the group of pixels 112 associated with the key element 101 is approximately 3 mm i.e. 3 mm+/−0.1 mm. Thereby it is achieved that an approximately 45 pixel by 45 pixel image provided by a group of pixels 112 may be displayed via the transmitting part 102 and this image may be seen from an angle of view 114 of a user 103 in the range of 45° to 135°.

In an embodiment, the dynamic display keyboard 100 may additionally comprise a printed circuit board (PCB) 115 comprising a plurality of pads 119 for determining whether a key element 101, 108 has been pressed. Light passages 116, such as holes, are included in the printed circuit board 115. The light passages 116 are positioned under the dome elements 106, 107, 109. The PCB is positioned between the display unit 111 and the elastic and flexible mat 105.

Each pad 119 comprises a first and a second pad part, and the first pad part is electrically isolated from the second pad part. When a key element 101 is depressed, a conductive element 120 is brought into contact with the first and second pad parts thereby short circuiting the first and second pad parts of at least one pad 119, thereby enabling detection of the depressed key element 101.

In an embodiment, a processing unit 1001 may be communicatively coupled to the light generating layer 111 via a wireless and/or wired communication link such as Bluetooth or cable. The processing unit 1001 may determine which characters are to be display on which key elements 101 by providing a control signal to the respective group of pixels 112 under the key elements 102. In an embodiment, the processing device 1001 further comprises a power providing unit such as a connection to a power grid and/or an battery.

In an embodiment, anyone of the below embodiments of FIGS. 19 and 21 and 22 and 23 and 24 and 25 may be communicatively coupled to a processing device 1001 as disclosed above.

In an embodiment, the PCB circuit is communicatively coupled to the processing unit 1001 via a wireless and/or wired communication link such as Bluetooth or cable. The value of a detected depressed key element 101 may be transmitted from the PCB circuit to the processing unit 1001 for further processing.

FIG. 19 shows an embodiment 200 of a dynamic display keyboard. As in the above embodiment 100, the dynamic display keyboard 200 comprises a key element 101 comprising a transparent part 102. The transparent part 102 may be connected to the key element 201 by gluing, vulcanization, welding or the like.

Further, as described above, the dynamic display keyboard 200 further comprises a mat 105 made of an elastic and flexible material such as rubber. The rubber mat 105 may comprise a plurality of elevated elements such as dome elements 201, 202 capable of providing a tactile feedback as described above.

The dome elements 201, 202 of FIG. 19 may comprise a cross-sectional form being trapezium shaped in the plane illustrated in FIG. 19. Further, the cross sectional form of the dome elements 201, 202 may be square-shaped along the X-X plane. As above, the rubber mat 105 are open in both ends 203, 204 such as to enable light to pass the dome element from a light generating device 111 to the transparent part 102.

In this embodiment, the dynamic display keyboard 200 may comprise light generating device 111 in the form of a touch sensitive display utilizing capacitive detection. An electrically insulating layer 206 such as a plastic or rubber may be deposited on the light generating layer with openings corresponding to the groups of pixels 112 defining the values of the key elements 101. The electrically insulating layer may thus be positioned between the light generating device 111 and the mat 105.

In an embodiment, the electrically insulating layer 206 may be transparent.

In an embodiment, the electrically insulating layer 206 may be comprised in the mat 105 such that the mat 105 constitutes both the isolating layer and the layer comprising the dome element.

In this embodiment, the rubber mat 105 further comprises fixators 205 to which the key elements 101 may be fixated e.g. by gluing, vulcanization, welding or the like. The distance between to opposing inner sides of the fixators 205 may correspond to size of the transparent part 102 in the respective dimensions of the plane containing the transparent part 102. The fixators 205 may be made of a hard plastic or rubber material such as to provide a stable platform on which the key element 101 may be placed.

In an embodiment, the fixators 205 and the mat 105 and the key element 101 are able to conduct an electric current. For example, the hard plastic or rubber of the fixators may be doped with a metallic powder such as iron or the like. Alternatively or additionally, the fixators 205 may contain an electric wire providing an electrically closed loop. Additionally, the mat 105 comprising the dome elements 106, 107, 109 may be made of an elastic plastic or rubber doped with a metallic powder such as iron Fe or the like. In an embodiment, the transmitting part 102 may also be made of a electrical conducting material such as electrical conducting silica glass (e.g. silica glass doped with iron Fe or manganese Mn).

In an embodiment, the light generating device 111 is a touch sensitive display with capacitive detection.

In an embodiment, the fixators 205 are cast together with the dome elements 201 during production of the mat 105.

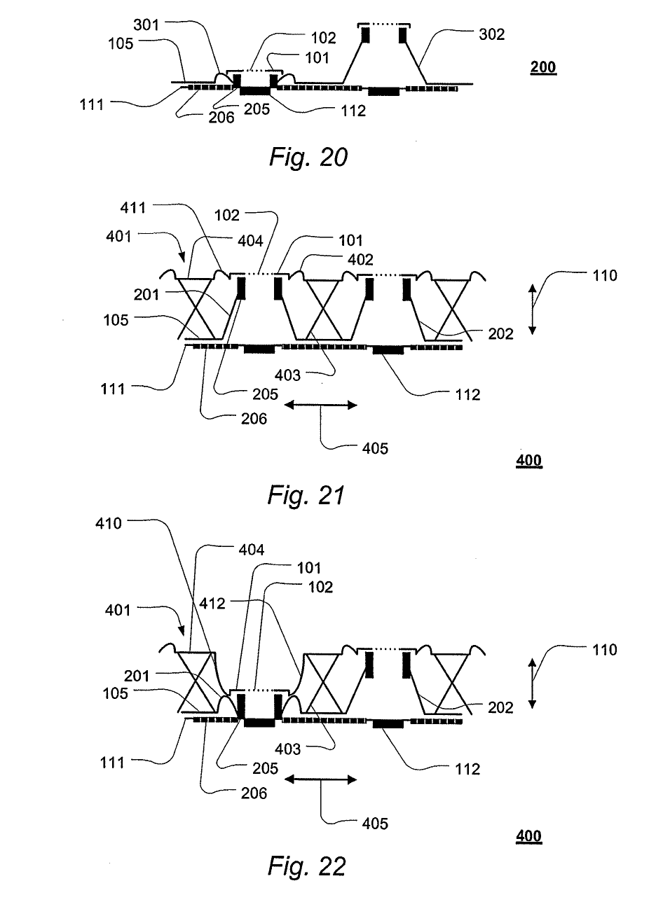

FIG. 20 shows an embodiment in which a key element 101 of the dynamic display keyboard 200 comprising electrically conducting fixators is in a depressed state. In this embodiment, the light generating device 111 is a touch sensitive display with capacitive detection. Thereby, when a key element 101 is depressed, the electrically conductive fixators 205 of the key element 101 is brought into contact with the electric field of the capacitive detection and thereby, the touch sensitive display may detect the depressed key element 101. Thereby, the dynamic display keyboard 200 may be used in combination with a touch sensitive display which may provide the value of the key elements 101 by displaying respective key values under respective key elements 101 and the touch display may further provide detection of a depressed key element 101 by detecting changes to the electric field provided by the capacitive detection. 301 and 302 denotes depressed/flexed dome elements 201, 202. The detected depressed key value may be transmitted to the processing unit 1001 for further processing.

In an alternative embodiment, the light generating device 111 may be a non-touch sensitive display and the dynamic display keyboard may, as in embodiment 100, comprise a PCB layer 115 and pads 119 and 120 for detection of a depressed key.

FIG. 21 shows an embodiment 400 of the dynamic display keyboard 200 further comprising a layer 401 in which the key elements 101 are included.

The layer 401 may be comprise a collar/ridge 402. The collar/ridge 402 is made of an elastic and flexible material such as rubber. Additionally, the layer 401 may comprise a rigid part 404 made of a hard and non-flexible plastic.

Between the rigid part 404 and the mat 105 (in the direction 110), supporting elements 403 may be positioned i.e. between the dome elements 201 of the mat 105 (in the direction 406). The supporting elements 403 supports the layer 401. The supporting elements 403 may be glued or vulcanized or welded to the rigid part 404 and the mat 105.

The key elements 101 comprises a transparent part 102 i.e. a transparent window. The key elements 101 may be glued or vulcanized or welded to the collar/ridge 402.

In an embodiment, the collar/ridge 402 is made of a transparent elastic and flexible material.

In an embodiment, the dynamic display keyboard 400 further comprises an electrically insulating layer 206 such as a plastic or rubber deposited on the light generating layer 111 with openings corresponding to the groups of pixels 112 defining the values of the key elements 101.

In an embodiment, the light generating layer 111 of the dynamic display keyboard 400 is a touch sensitive display with capacitive detection.

In an alternative embodiment, the dynamic display keyboard 400 comprises a PCB circuit on top of the light generating layer 111 as shown in FIG. 18.

In an embodiment, the height from the top of the light generating layer 111 and to the top of the transparent window 102 is chosen in the range from 2.5 mm to 3.5 mm. In an embodiment, the height from the top of the light generating layer 111 and to the top of the transparent window 102 is chosen in the range from 2 mm to 3 mm. In an embodiment, the height from the top of the light generating layer 111 and to the top of the transparent window 102 is chosen to be 3 mm. Thereby, a large angle of view of the key values associated with a key element for a user is provided by the dynamic display keyboard.

FIG. 22 shows an embodiment in which a key element 101 of the dynamic display keyboard 400 is in a depressed state. In the depressed state, the dome element 201 of the depressed key element 101 and the collar/ridge 402 of the depressed key 101 are flexing to provide the tactile feedback of the key element 101.

In an embodiment, the light generating device 111 is a touch sensitive display with capacitive detection. Thereby, when a key element 101 is depressed, the electrically conductive fixators 205 of the key element 101 is brought into contact with the electric field of the capacitive detection and thereby, the touch sensitive display may detect the depressed key element 101. Thereby, the dynamic display keyboard 400 may be used in combination with a touch sensitive display which may provide the value of the key elements 101 by displaying respective key values under respective key elements 101 and the touch display may further provide detection of a depressed key element 101 by detecting changes to the electric field provided by the capacitive detection. 301 and 302 denotes depressed/flexed dome elements 201, 202 and 410 and 412 denotes depressed/flexed collar/ridge elements 402 and 411.

In an alternative embodiment, the light generating device 111 may be a non-touch sensitive display and the dynamic display keyboard 400 may, as in embodiment 100, comprise a PCB layer 115 and pads 119 and 120 for detection of a depressed key.

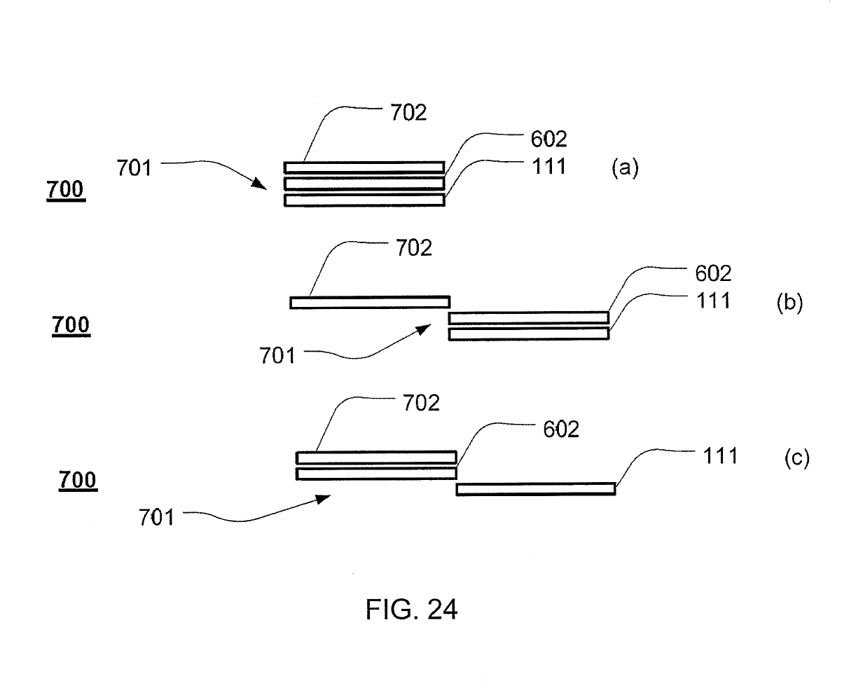

FIG. 24 shows an embodiment 700 of a device comprising a dynamic display keyboard 701 according to anyone of embodiments 1, 2, and 4, i.e. comprising a detachable part 602 and a light generating layer 111. Additionally, the device further comprises a second light generating layer 702 such as a LCD flatpanel or the like.

The device 700 may comprise a sliding mechanism such that the device may be in a closed state as indicated in FIG. 24 (a), a state 24 (b) in which the dynamic display keyboard 701 comprising the detachable part 602 and the light generating layer 111 are slid out such that the dynamic display keyboard may be used, and a state 24 (c) in which only the second light generating layer 702 is slid out in order to provide a larger total light generating device area.

In an embodiment, the detachable part 602 and the light generating layer 111 may be hinged together in order to enable the sliding according to FIG. 24 (b). FIG. 24 (c) may be achieved by opening the hinges hinging the detachable part 602 and the light generating layer 111 together.

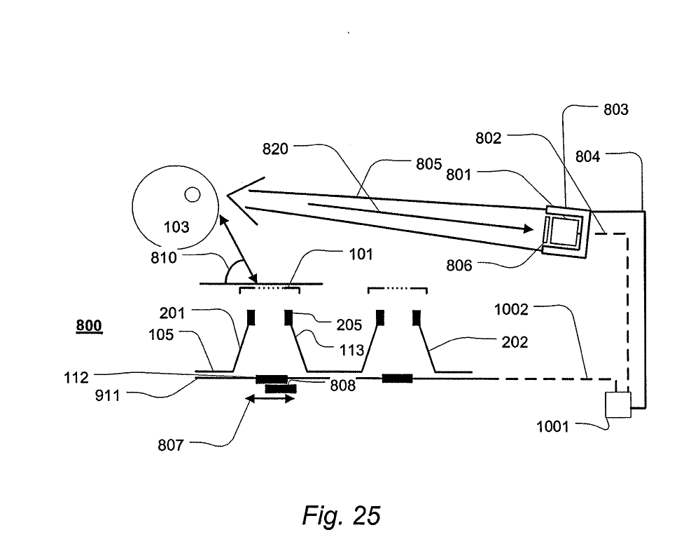

FIG. 25 shows an embodiment of a dynamic display keyboard 800 providing an increased angle of view of the key elements 101.

The dynamic display keyboard may be as shown in FIG. 18 or 19 or 21. Additionally, the dynamic display keyboard 800 may comprise a detector 801. The detector 801 may be a camera recording images of the user 103 and more specific of the user's head and/or face. Thus, the detector 801 may be a tracker tracking the head of the user 103.

The images from the detector 801 may be transmitted to the processing unit 1001 via a wireless and/or wired communication link such 802 as a Bluetooth link or a cable.

The processing unit 1001 may calculate the user's head's distance and angle with respect to the dynamic display keyboard 800 based on the received images from the detector 801.

In an embodiment, the processing unit 1001 may utilize edge detection in order to determine the head/face of the user from the images received.

In an alternative embodiment, the dynamic display keyboard 800 may further comprise an IR transmitter 803 communicatively coupled to the processing unit 1001 via a wireless and/or wired communication link such 804 as a Bluetooth link or a cable. The IR transmitter may illuminate the head/face of the user 103 with IR light 805. An optical filter 806 may be placed in front of the detector 801 such as a bandpass filter. The optical filter may restrict the bandwidth of the light 820 reaching the detector to e.g. IR light. Thereby, high contrast may be achieved in the images recorded by the detector. The images may be transmitted to the processing unit.

Based on the calculated angle and distance of the user's head/face with respect to the dynamic display keyboard 800, the processing unit 1001 may determine that the group of pixels 112 providing the values of respective key elements 101 may be changed to another group of pixels 808. The other group of pixels 808 may for example correspond to the group of pixels 112 translated in the plane 807 of the light generating layer 111 such as to compensate for the angle and/or distance of the user's head/face. Thereby, the angle of view may be increased with respect to the user 103.

In an embodiment, the angle of view may be changed manually by a user by activating a button connected to the processing device and e.g. comprising a number of steps. For example, one step corresponding to an angle of view between 90 degrees and 60 degrees and another step corresponding to an angle of view between 60 and 30 degrees.

In one aspect, the above described dynamic display keyboard may be used to e.g. provide different values to a key in a keyboard. One day, the keyboard may provide Latin alphabet key values and the next day Cyrillic alphabet key values. Alternatively or additionally, the dynamic display keyboard may ease use of special keys such as Alt Gr, CTRL, etc. When pressing one of these special keys, the dynamic display keyboard may only illuminate the keys and key values that can be reached in combination with the special key pressed down.

In an embodiment, the keyboard may be included in a computer system via a wired and/or wireless communication link such as an electric cable and/or a Bluetooth link. In this embodiment, the keyboard may comprise a short-range radio receiver and transmitter (e.g. a Bluetooth transmitter and receiver) and the computer system may comprise a similar short-range radio receiver and transmitter. Additionally or alternatively, the keyboard and the computer system may comprise a socket for an electric wire via which the computer system and the keyboard may be connected via an electric wire.

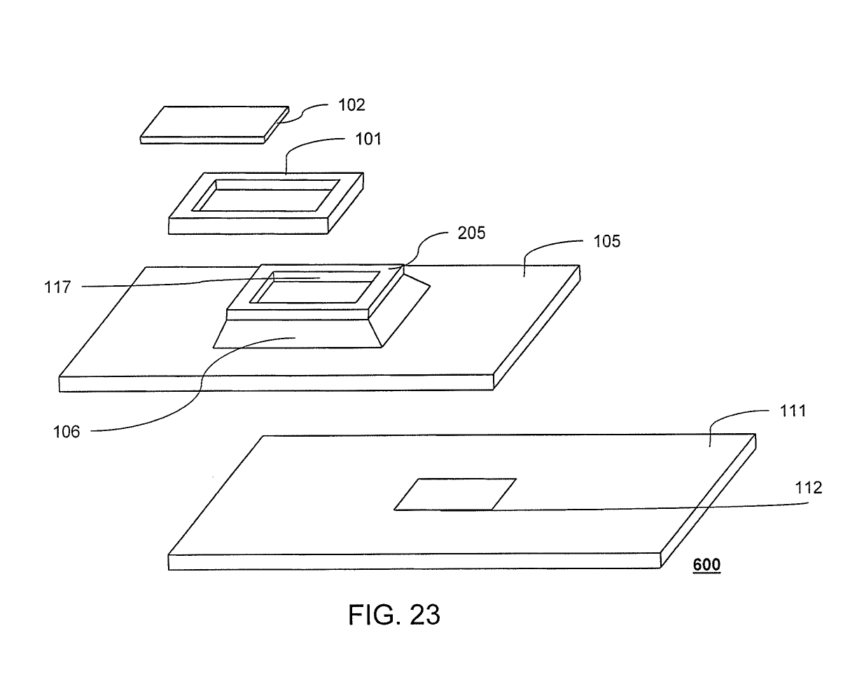

FIG. 23 shows an embodiment of a key 600 for use in a keyboard as described above under FIGS. 18 to 22 and FIG. 25. The key element 101 comprises a transmitting part 102 capable of transmitting at least a part of light incident on the transmitting part 102.

In an embodiment, the transmitting part 102 may be made of a transparent polymer or of silica glass or the like i.e. a material having a high transmittance of the incident light. In an additional embodiment, the transmitting part 102 is made of a material having a high transmittance of incident light visible to a human being i.e. in the wavelength range from approximately 380 nm (violet light) to 750 nm (red light).

The transmitting parts 102 may be positioned at the top of the key element 101 or included in the key element 101.

The key element 101 may be fixedly connected to an elevated element 106 contained in a mat 105 made of an elastic and flexible material such as rubber. The dome element 106 provide a tactile feedback. The dome element 106 may be made in the same material as the mat 105. The mat 105 comprising the dome element 106 may in one embodiment be cast in one piece. The dome element 106 may be open in both ends 117 (only one open end is visible in FIG. 23) and hollow such as to enable passage of light e.g. from a group of pixies 112 contained in a display unit 111.

Thus, the dome element 106 may be hollow in order to reduce absorption of light in them. The dome element 106 may further be open in both ends 117. Thereby, the dome element 106 enable passage of light to the transmitting part 102.

In an embodiment, the inner surface of the dome element 106, 107, 109 may be coated with a reflecting material such as e.g. a thin metal layer such as aluminium.

The number of dome elements 106 fixedly connected to a key element 101 may depend on the size of the key element such that a large key (e.g. a space key) may be connected to a plurality of dome elements and a small key (e.g. a character key) may be connected to a single dome element.

In an embodiment, the dome element 106 provides control of the dimensions in which the key elements 101 may move in. The dome element 106 may in an embodiment restrict the direction in which the key element 101 may move. In an embodiment, the direction to which the key element may move may be the direction perpendicular to the rubber mat 105 or substantially perpendicular to the rubber mat 105 e.g. 90 degrees+/−5 degrees.

In order to have the dome element 106 deform, an external force provided by a user pressing the associated key element 101, is required. The dome element 106 may be made of a soft plastic or rubber or any other material capable of deforming along the direction of movement when an external force having a component in the direction of movement is applied to the key element 101. In an embodiment, the dome element 106 may be such as to require a threshold force in the direction of movement 110 before deforming thereby providing a tactile response to a user applying a force to the key element 101 and making the dome element able to sustain the weight of the key element 101 without any substantial deformation in the direction of movement of the key element when an external force is not applied.

Thereby, the dome element 106 is able to provide a tactile feedback in response to a user action e.g. a user pressing the key element.

The key element 101 may be made of a material harder than the dome element. For example, the key element 101 may be made of melamine resin.

In an embodiment, the maximal height from the top of a transmitting part 102 of a key element 101 to the bottom of the mat 105 is approximately 3 mm i.e. 3 mm+/−0.1 mm. Thereby it is achieved an angle of view of a user in the range of 45° to 135° of the key element 101.

In an embodiment, the key element further comprises a fixator 205 to which the key elements 101 may be fixedly connected e.g. by gluing, vulcanization, welding or the like. The fixator 205 is cast during production of the mat 105. The fixator 205 and the mat 105 comprising the dome elements 106 may be made in a electrical conductive material such as rubber doped with iron Fe. In an embodiment, the fixator 205 may be made of a hard plastic or rubber material such as to provide a stable platform on which the key element 101 may be placed.

In an embodiment, a keyboard comprises a plurality of the key elements 101 described above,

An effect of such a keyboard is that it enables persons with long fingernails to use a touch sensitive display unit. Prior to the present invention, persons with long fingernails could attempt to use the nails in order to press a key on the touch sensitive display unit. However, since a nail is none-conducting, the attempt to press the key would not be registered via the capacitive detection. Applying a keyboard as disclosed above, the person with long fingernails will use the finger to press the key element, and the nail may be positioned in an air-gap between the key elements. The finger is conductive and thus, the capacitive detection will detect the pressed key element.

In an embodiment, the dynamic display keyboard of FIG. 18 a) or 2 or 4 or 8 may further comprise a photo-detector 1200 in proximity to each group of pixels associated with a respective key element 101. The photo-detector may be communicatively coupled via Bluetooth or a wire to the processing unit 1001. The photo-detector may detect the intensity of light reaching the photo-detector 1200. When a key-element is depressed, the intensity of light detected by the photo-detector decreases due to 1) the object (e.g. a finger) placed on the key element 101 and thus also the transmitting part 102 by the user and 2) the depressed key element may further block for light reaching the photo-detector 1200. Thus, the intensity of light detected by the photo-detector may be used to determine when a key element is depressed. For example, the processing unit may receive intensity-measurements from the photo-detectors each millisecond, and if one or more of the intensities from the respective photo-detectors falls below a predetermined threshold value, then the processing unit 1001 may determine that the one or more key elements 101 associated with the photo-detectors measuring a decrease in intensity, have been depressed.

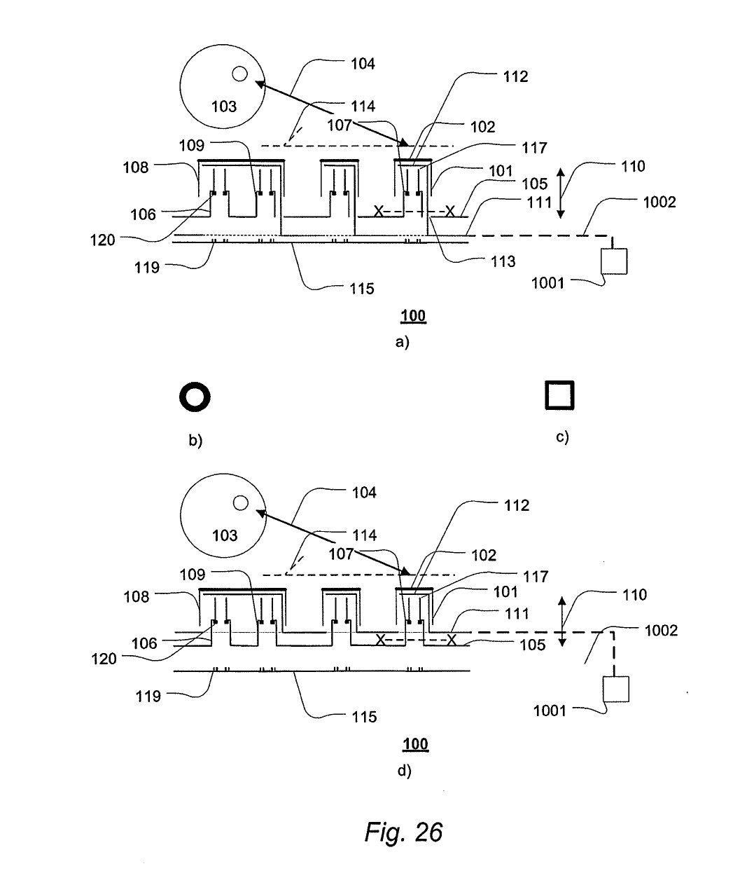

FIG. 26 a) shows an embodiment of a dynamic display keyboard 100. The dynamic display keyboard comprises a plurality of key elements 101 e.g. a plurality of alpha-numeric keys. Each of the key elements 101 comprises a transmitting part 102 capable of transmitting at least a part of light incident on the transmitting part 102.

In an embodiment, the transmitting part 102 may be made of a transparent polymer or of silica glass or the like i.e. a material having a high transmittance of the incident light. In an additional embodiment, the transmitting part 102 is made of a material having a high transmittance of incident light visible to a human being i.e. in the wavelength range from approximately 380 nm (violet light) to approximately 750 nm (red light).

The transmitting parts 102 may be positioned at the top of the key elements 101 as indicated in FIG. 26 a). Thereby, light incident on the transmitting part 102 from a light generating device, such as a group of pixels 112 in a light generating device 111 (such as a flat-panel display e.g. OLED or LCD), may reach a user 103 e.g. via light path 104. The transmitting parts 102 may be connected to the key element 101 via glue, vulcanization, or the like.

The dynamic display keyboard 100 may further comprise a mat 105 made of an elastic and flexible material such as rubber. The mat 105 may comprise a plurality of elevated elements such as dome elements 106, 107, 109 capable of providing a tactile feedback. The dome elements 106, 107, 109 may be made in the same material as the mat 105. The mat 105 comprising the dome elements 106, 107, 109 may in one embodiment be cast in one piece. The dome elements 106, 107, 109 may be open in one end 118 facing the mat 105 and closed in the other end 117 facing the transmitting part 102. Further, the dome elements 106, 107, 109 may be hollow.

Each key element 101 is fixedly connected to at least one dome element 106 as disclosed below. As seen in FIG. 26 a), key element 101 is in fixedly connected to one dome element 107, and key element 108 is fixedly connected to two dome element 106 and 109. The number of dome elements 106, 107, 109 fixedly connected to a key element 101, 108 may depend on the size of the key element such that a large key (e.g. a space key) may be connected to a plurality of dome elements and a small key (e.g. a character key) may be connected to a single dome element.

In a computer keyboard, for example, a SHIFT key may be fixedly connected to two dome elements, an alpha-numeric key may be fixedly connected to one dome element, and the spacebar may be fixedly connected to four dome elements.

The term fixedly connected is to be understood as the key element may be resting on the dome element and/or it may be glued or vulcanized to the dome element and/or welded to the dome element and/or cast with the dome element.

In an embodiment, the dome elements 106, 107, 109 provides control of the dimensions in which the key elements 101, 108 may move in. The dome elements 106, 107, 109 may in an embodiment restrict the direction in which the key elements 101, 108 may move. In an embodiment, the direction to which the key elements may move may be the direction 110 perpendicular to the rubber mat 105 or substantially perpendicular to the rubber mat 105 e.g. 90 degrees+/−5 degrees.

In order to have the dome element deform, an external force provided by a user pressing the associated key element, is required. The dome elements may be made of a soft plastic or rubber or any other material capable of deforming along the direction of movement 110 when an external force having a component in the direction of movement 110 is applied to the key element 101. In an embodiment, the dome element 106 may be such as to require a threshold force in the direction of movement 110 before deforming thereby providing a tactile response to a user applying a force to the key element 101 and making the dome element able to sustain the weight of the key element 101 without any substantial deformation in the direction of movement 110 of the key element when an external force is not applied.

Thereby, the dome element 106, 107, 109 is able to provide a tactile feedback in response to a user action e.g. a user pressing the key element.

The key element 101 may be made of a material harder than the dome element. For example, the key element 101 may be made of melamine resin.

FIG. 26 b) shows a circular cross-sectional view along the X-X axis of a dome element 106, 107, 109.

FIG. 26 c) shows a square cross-sectional view along the X_X axis of a dome element 106, 107, 109.

The dynamic display keyboard 100 may further comprise at least one display unit 111. The display unit 111 is adapted to provide light to the plurality of transmitting parts 102. The display unit 111 may comprise a LCD or OLED in which a pixel or a group of pixels 112 of the display are assigned to a key element 101. As seen in FIG. 26 a), a group of pixels 112 are stamped out from the display unit 111 and the group of pixels 112 are positioned between the key element 101 comprising the transmitting part 102 and the dome element 106, 107, 109. Therefore, light emitted by the group of pixels 112 may pass the transmitting part 102. The group of pixels 112 may comprise one or more pixels in one or two directions i.e. a linear or planar arrangement of pixels may be comprised in the group of pixels 112.

As seen in FIG. 26 a), the elastic and flexible mat is positioned between the display unit 111 and the plurality of key elements 101, 108.

In an embodiment, the dynamic display keyboard 100 may additionally comprise a printed circuit board (PCB) 115 comprising a plurality of pads 119 for determining whether a key element 101, 108 has been pressed. The pads may in an embodiment be made of carbon e.g. an electrically conducting carbon.

The PCB is positioned below the display unit 111.

Each pad 119 comprises a first and a second pad part, and the first pad part is electrically isolated from the second pad part. When a key element 101 is depressed, a conductive element 120 passes through an opening left in the light generating layer 111 by the group of pixels 112 stamped out in the display unit 111 and is brought into contact with the first and second pad parts thereby short circuiting the first and second pad parts of at least one pad 119, thereby enabling detection of the depressed key element 101.

Further, passages or openings 113, such as holes, are included in the mat 105. The passages 113 are placed such as to enable parts of the display unit 111 to be passed through the mat 105.

In an embodiment, a processing unit 1001 may be communicatively coupled to the light generating layer 111 via a wireless and/or wired communication link such as Bluetooth or cable. The processing unit 1001 may determine which characters are to be displayed on which key elements 101 by providing a control signal to the respective group of pixels 112 under the key elements 102. In an embodiment, the processing device 1001 further comprises a power providing unit such as a connection to a power grid and/or an battery.

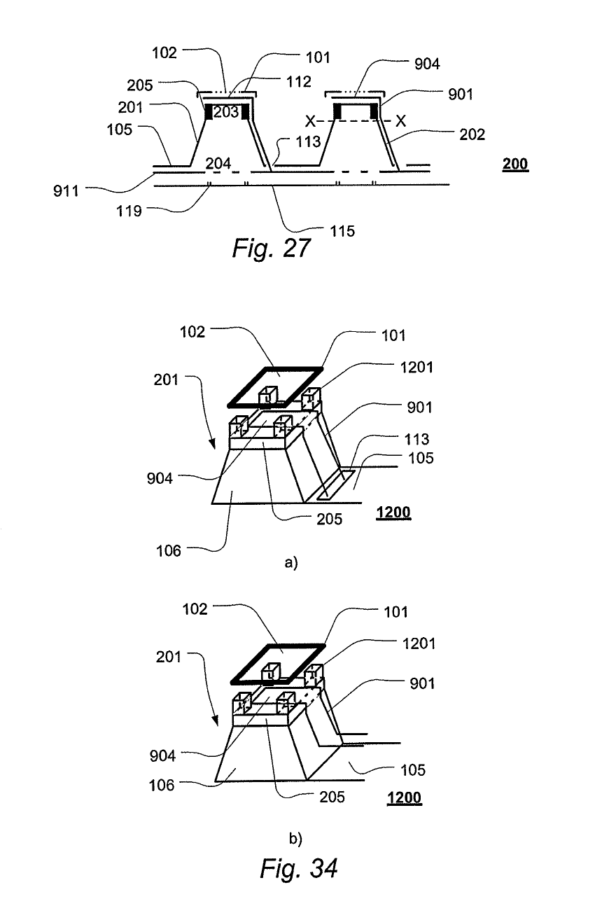

In an embodiment, anyone of the below embodiments of FIGS. 27 and 29 and 30 and 32 and 33 may be communicatively coupled to a processing device 1001 as disclosed above.

In an embodiment, the PCB circuit is communicatively coupled to the processing unit 1001 via a wireless and/or wired communication link such as Bluetooth or cable. The value of a detected depressed key element 101 may be transmitted from the PCB circuit to the processing unit 1001 for further processing.

In an embodiment as shown in FIG. 26 d), the display unit 111 may be placed above the mat 105 i.e. above the mat 105. In this embodiment, the mat 105 may be cast in one piece i.e. without the holes 113 of FIG. 26.

FIG. 33 shows an embodiment 900 of the display unit 111, wherein the display unit 111 comprises a thin flexible layer display unit 911 such as an OLED or the like.

In an embodiment, the thin layer display unit 911 is in the range 0.1 mm-0.2 mm.

The thin layer display unit 911 comprises a stamped out part 901, 902, 903 (defining respective light generating layers) for each of the plurality of key elements 101, 108, 117, which represents the plane of the thin layer display unit perpendicular to the direction 110 e.g. the plane of the keys in a computer keyboard. Each of the stamped out parts 901, 902, 903 constitutes individual display units contained in the thin layer display unit 911.

An outer part 904 of the stamped out part 901 is positioned between the transmitting part 102 and the dome element 107 of each of the key elements 101, 106, 109 as shown in FIG. 26. This may be achieved by lifting up the stamped out part 901 from the plane of the thin layer display unit 911, guiding it through the respective holes 116, 113 in the PCB 115 and the mat 105, respectively, and placing the outer part 904 of the stamped out part 901 under the transmitting part 102. Subsequently, the dome element 107 may be inserted into the key element 101 in order to provide tactile feedback to the key element 101. The outer part 904 is moveably connected to the key element 101. Thereby, the outer part 904 of each stamped out part 901, 902, 903 may move together with the key element 101 to which the outer part 904 is moveably connected for example when the key element is depressed.

In an embodiment, each pixel of the outer part 304 of each of the stamped out parts is addressed via a data-bus integrated in the thin layer display unit.

In an embodiment of FIG. 33, the stamped out part of each respective light generating layer comprises a first thickness 999 along a first side of the stamped out part and a second thickness 998 along a second side of the stamped out part. The thicknesses 999 and 998 may be above approximately 1 mm e.g. above 1.0 mm+/−0.1 mm. In an embodiment, the thicknesses 999 and 998 are 3.0 mm+/−0.5 mm.

The width 999 may enable flexibility in the group of pixels 112 of the thin flexible display unit 911 when the associated key element 101 is moving during a depressing from an equilibrium state or a return to the equilibrium state (un-pressed key element).

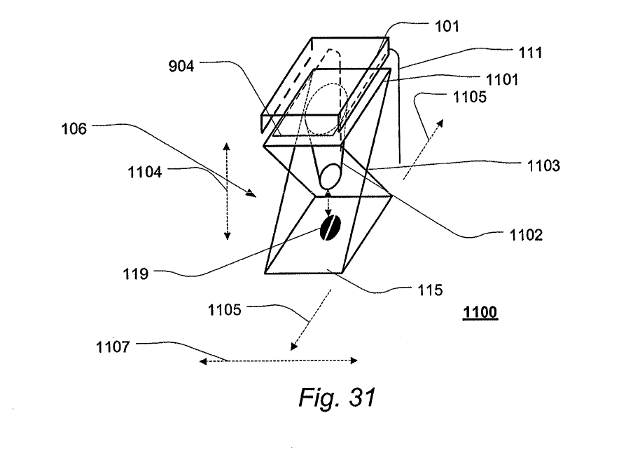

FIG. 31 shows an embodiment of a key 1100 in a dynamic keyboard comprising a scissor-switch.

The key 1100 comprises a scissor element 106. The scissor element 106 may comprise a closed top 1101 under which a rod 1102 may be attached by glue, vulcanization, welding or the like. The rod 1102 may be made of a conductive material such as iron doped rubber or the like. The scissor element 106 may further comprise two X-formed structures which may be collapsible around a pivotal point 1103 like an opening scissor. Further, the scissor element 106 may be fixedly connected to a key element 101 via spacers (not shown) placed at the corners of the top 1101. The spacers may be fixed to the key element 101 and to the top 1101 by glue, vulcanization, welding or the like. Thereby, the spacers create a gap between the top 1101 and the key element 101 in which gap, an outer part 904 of a stamped out part 901, 902, 903, may be placed. The outer part 904 is thus movable connected (not fixed) to the key element 101 or to the top 1101, but may glide on the surface of the top 1101 when the key element 101 is depressed. The outer part 904 is kept in place between the top 1101 and the key element 101 by its connection to the thin flexible layer display unit 911. Further, the spacers may additionally act as rails by which the outer part 904 may be kept in place in the lateral direction 1107.

When a force 1104 is applied to the key element 101 fixedly connected to the top 1101 via the spacers, the bottom part of the X-structures slides on a rail or track along the direction 1105 thereby reducing the height of the scissor element 106. At a point, the rod 1102 will come into physical contact with a pad arrangement 119 of the PCB 115, whereby electrical contact is made between the two pad parts and the key element 101 pertaining to the scissor element 106 may be detected as having been depressed.

The PCB 115 may be arranged in a mat-like structure as shown in FIG. 26 a) comprising at least one PCB for each key element 101. In an embodiment, the thin flexible layer display unit 911 is placed between the key elements and the PCB 115. Thereby, the PCB may be cast in one piece without openings for the display unit 111 (e.g. as seen in FIG. 26 a). In an alternative embodiment, the display unit 111 is placed below the PCB and thus the PCB 115 comprises openings enabling the stamped out part to pass through in order for the outer part 904 to be placed in the gap.

The embodiment 1100 may be used in a low profile type keyboard such as known from laptops and the like.

FIG. 27 shows an embodiment 200 of a dynamic display keyboard comprising a dome element. As in the above embodiment 100, the dynamic display keyboard 200 comprises a key element 101 comprising a transparent part 102. The transparent part 102 may be connected to the key element 201 by gluing, vulcanization, welding or the like.

Further, as described above, the dynamic display keyboard 200 further comprises a mat 105 made of an elastic and flexible material such as rubber. The rubber mat 105 may comprise a plurality of elevated elements such as dome elements 201, 202 capable of providing a tactile feedback as described above.

The dome elements 201, 202 of FIG. 27 may comprise a cross-sectional form being trapezium shaped in the plane illustrated in FIG. 27. Further, the cross sectional form of the dome elements 201, 202 may be square-shaped along the X-X plane. As above, the rubber mat 105 is open in one end 204 and closed in the other end 204.

In an embodiment, the dynamic display keyboard 200 may comprise thin flexible layer display unit 911

A group of pixels 112 are positioned between the key element 101 comprising the transmitting part 102 and the closed dome element 205. Light emitted by the group of pixels 112 may pass the transmitting part 102. The group of pixels 112 may comprise one or more pixels in one or two directions i.e. a linear or planar arrangement of pixels may be comprised in the group of pixels 112.

The part of the display unit 904 comprising the group of pixels 112 may be placed against the key element 101 or against the top of the closed dome element 205 or it may be in no physical contact with the top of the closed dome element 205 or the key element 101 i.e. hovering in between the key element 101 and the dome element 205 by being supported by the rest of the stamped out part 901.

Further, passages 113, such as holes, are included in the mat 105. The passages 113 are placed such as to enable parts of the thin flexible layer display unit 911 to be passed through the mat 105.

In this embodiment, the rubber mat 105 further comprises fixators 205 to which the key elements 101 may be fixated e.g. by gluing, vulcanization, welding or the like. The horizontal distance between to opposing inner sides of the fixators 205 may correspond to size of the transparent part 102 in the respective dimensions of the plane containing the transparent part 102. The fixators 205 may be made of a hard plastic or rubber material such as to provide a stable platform on which the key element 101 may be placed.

In an embodiment, the fixators 205 are able to conduct an electric current. For example, the hard plastic or rubber may be doped with a metallic powder such as iron or the like. Alternatively or additionally, the fixators 205 may contain an electric wire providing an electrically closed loop.

In an embodiment, the fixators 205 are cast during production of the mat 105.

In an embodiment, the dynamic display keyboard 100 may additionally comprise a printed circuit board (PCB) 115 comprising a plurality of pads 119 for determining whether a key element 101, 108 has been pressed.

The PCB is positioned below the display unit 111 and the elastic and flexible mat 105.

Each pad 119 comprises a first and a second pad part, and the first pad part is electrically isolated from the second pad part. When a key element 101 is depressed, a conductive element 120 passes through an opening left in the light generating layer 111 by the group of pixels 112 stamped out in the display unit 111 and is brought into contact with the first and second pad parts thereby short circuiting the first and second pad parts of at least one pad 119, thereby enabling detection of the depressed key element 101.

Further, passages or openings 113, such as holes, are included in the mat 105. The passages 113 are placed such as to enable parts of the display unit 111 to be passed through the mat 105.

In an embodiment, the display unit 111 is placed above the mat 105 such that the mat 105 may be cast without the openings 113.

FIG. 34 a) shows an embodiment of a key 1200 of a dynamic display keyboard. The key comprises a dome element 201 and pertaining key element 101 comprising a transparent part 102. The dome element 201 is cast e.g. in one piece and the fixator 205 may be cast in the same production step. The fixator 205 is solid in order to enable an outer part 904 of a stamped out part 901 of a display unit (not shown) to be placed on the fixator 205. The display unit (not shown) may be placed below the mat 105. A number of spacers 1201 (in this embodiment four spacers 1201 placed at each corner of the fixator 205; alternatively two spacers each running along the part 904 of the display positioned between the key element and the fixator 205) are fixedly connected to the fixator 305 by glue, vulcanization, welding or the like. On top of the spacers, the key element 101 is fixedly connected using glue, vulcanization or the like. Thereby, a volume exist between the key element 101 and the fixator 205 in which volume the outer part 904 of the stamped out part 901 of the display unit (not shown) may be positioned. An opening 113, such as a hole or the like, is contained between the dome element such that the stamped out part 901 may be guided through the opening 113 such that the outer part 904 of the stamped out part 901 may be placed in the volume (either against the fixator 205 or the key element 101 or floating in the air due to the connection to the stamped out part 901). Thereby, the outer part providing the alpha-numeric value of the key element 101 is able to move freely in the plane of the fixator 205 when the key element 101 is depressed.

FIG. 34 b) shows an embodiment of FIG. 34 a) in which the display unit 111 is placed above the mat 105. In this embodiment, the mat 105 may be cast in one piece i.e. without the holes 113 of FIG. 34 a).

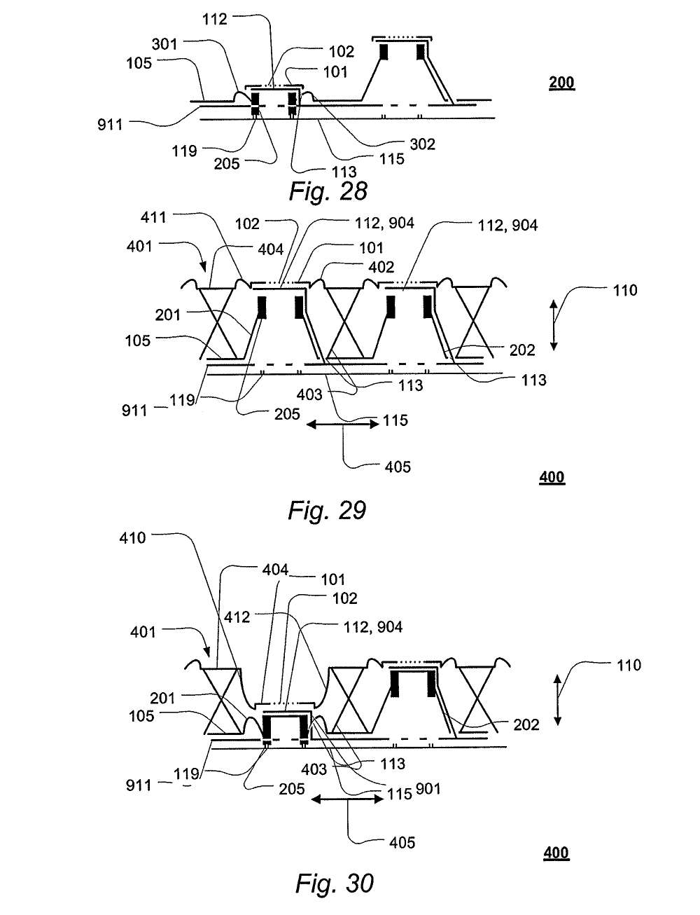

FIG. 28 shows an embodiment in which a key element 101 of the dynamic display keyboard 200 comprising electrically conducting fixators is in a depressed state. In this embodiment, the thin flexible layer display unit 911 is a touch sensitive display with capacitive detection. Thereby, when a key element 101 is depressed, a conductive element 205 passes through an opening left in the light generating layer 111 by the group of pixels 112 stamped out in the display unit 111 and is brought into contact with the first and second pad parts of the PCB 115 thereby short circuiting the first and second pad parts of at least one pad 119, thereby enabling detection of the depressed key element 101 by the PCB 115. The detected depressed key value may be transmitted to the processing unit 1001 for further processing.

FIG. 29 shows an embodiment 400 of the dynamic display keyboard 200 further comprising a layer 401 in which the key elements 101 are included.

The layer 401 may be comprise a collar/ridge 402. The collar/ridge 402 is made of an elastic and flexible material such as rubber. Additionally, the layer 401 may comprise a rigid part 404 made of a hard and non-flexible plastic.

Between the rigid part 404 and the mat 105 (in the direction 110), supporting elements 403 may be positioned i.e. between the dome elements 201 of the mat 105 (in the direction 406). The supporting elements 403 supports the layer 401. The supporting elements 403 may be glued or vulcanized or welded to the rigid part 404 and the mat 105.

The key elements 101 comprises a transparent part 102 i.e. a transparent window. The key elements 101 may be glued or vulcanized or welded to the collar/ridge 402.

In an embodiment, the collar/ridge 402 is made of a transparent elastic and flexible material.

The dynamic display keyboard further comprises a group of pixels 112 associated with an outer part 904 of a stamped out part 901 of the display unit 901. The stamped part 901 is guided through a hole 113 in the mat 105 such that the outer part 904 may be positioned between the key element and the fixators 205.

In an embodiment, the dynamic display keyboard 400 comprises a PCB circuit 115 below the thin flexible layer display unit 911.

In an embodiment, the height from the top of the outer part 904 to the thin flexible layer display unit 911 plane is in the range 2.0 mm to 3.0 mm i.e. 3.0 mm+/−0.3 mm.

FIG. 30 shows an embodiment in which a key element 101 of the dynamic display keyboard 400 is in a depressed state. In the depressed state, the dome element 201 of the depressed key element 101 and the collar/ridge 402 of the depressed key 101 are flexing to provide the tactile feedback of the key element 101.

In an embodiment, when a key element 101 is depressed, the electrically conductive fixators 205 passes through an opening 113 left in the light generating layer 111 by the group of pixels 112 stamped out in the display unit 111 and is brought into contact with the first and second pad parts of the PCB 115 thereby short circuiting the first and second pad parts of at least one pad 119, thereby enabling detection of the depressed key element 101 by the PCB 115. The detected depressed key value may be transmitted to the processing unit 1001 for further processing. 301 and 302 denotes depressed/flexed dome elements 201, 202 and 410 and 412 denotes depressed/flexed collar/ridge elements 402 and 411.

This embodiment, among other things, provides a keyboard with a layer 401 that is easily cleaned and which prevents dust and other things or fluids from falling in between the dome elements 201.

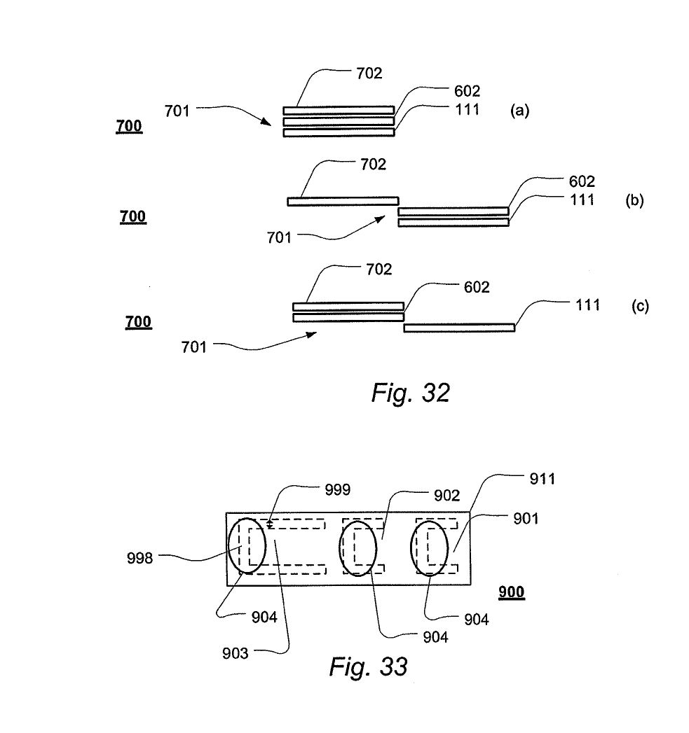

FIG. 32 shows an embodiment 700 of a device comprising a dynamic display keyboard 701 according to anyone of embodiments 1, 2, and 4, i.e. comprising a detachable part 602 and a thin flexible layer display unit 911. Additionally, the device further comprises a second light generating layer 702 such as a LCD flatpanel or the like.

The device 700 may comprise a sliding mechanism such that the device may be in a closed state as indicated in FIG. 32 (a), a state 7 (b) in which the dynamic display keyboard 701 comprising the detachable part 602 and the thin flexible layer display unit 911 are slid out such that the dynamic display keyboard may be used, and a state 7 (c) in which only the second light generating layer 702 is slid out in order to provide a larger total light generating device area.

In an embodiment, the detachable part 602 and the thin flexible layer display unit 911 may be hinged together in order to enable the sliding according to FIG. 32 (b). FIG. 32 (c) may be achieved by opening the hinges hinging the detachable part 602 and the thin flexible layer display unit 911 together.

In one aspect, the above described dynamic display keyboard may be used to e.g. provide different values to a key in a keyboard. One day, the keyboard may provide Latin alphabet key values and the next day Cyrillic alphabet key values. Alternatively or additionally, the dynamic display keyboard may ease use of special keys such as Alt Gr, CTRL, etc. When pressing one of these special keys, the dynamic display keyboard may only illuminate the keys and key values that can be reached in combination with the special key pressed down.

In an embodiment, the keyboard may be included in a computer system via a wired and/or wireless communication link such as an electric cable and/or a Bluetooth link. In this embodiment, the keyboard may comprise a short-range radio receiver and transmitter (e.g. a Bluetooth transmitter and receiver) and the computer system may comprise a similar short-range radio receiver and transmitter. Additionally or alternatively, the keyboard and the computer system may comprise a socket for an electric wire via which the computer system and the keyboard may be connected via an electric wire.

FIG. 35 a) shows a system 100 according to an embodiment. The system 100 comprises a keyboard 197 and a key-value generating unit 196

The keyboard comprises a plurality of key elements 101. In an embodiment, each of the key elements 101 comprises a reflecting part 102 capable of reflecting at least a part of light incident on the reflecting part 102. In yet an alternative embodiment, a part (e.g. 50% of the key elements 101) of the key elements 101 comprises a reflecting part 102.

In the embodiments where at least a part of the key elements 101 comprises respective reflecting parts, the reflecting part 102 may comprise a diffuse reflecting layer. In the above and below, a diffuse-reflecting layer is a reflecting layer reflecting electromagnetic radiation in all directions. In an embodiment, the reflected electromagnetic radiation is visible to a human being i.e. in the wavelength range from approximately 380 nm (violet light) to approximately 750 nm (red light).

The reflecting parts 102 may be positioned at the top of the key elements 101 as indicated in FIG. 35 a). The reflecting parts 102 may be fixedly connected to the key element 101 via glue, vulcanization, or the like.

The keyboard 197 may further comprise a mat 105 made of an elastic and flexible material such as rubber. The rubber mat 105 may comprise a plurality of elevated elements such as dome elements 106, 107, 109 capable of providing a tactile feedback. The dome elements 106, 107, 109 may be made in the same material as the mat 105. The mat 105 comprising the dome elements 106, 107, 109 may in one embodiment be cast in one piece. The dome elements 106, 107, 109 may be open in both ends 117, 118 and hollow such as to enable passage of light.

Each key element 101 may be fixedly coupled to at least one dome element 106. As seen in FIG. 35 a), key element 101 is in fixedly coupled to one dome element 107, and key element 108 is fixedly copied to two dome element 106 and 109. The number of dome elements 106, 107, 109 fixedly coupled to a key element 101, 108 may depend on the size of the key element such that a large key (e.g. a space key) may be connected to a plurality of dome elements and a small key (e.g. a character key) may be connected to a single dome element.

In a computer keyboard, for example, a SHIFT key may be fixedly coupled to two dome elements, an alpha-numeric key may be fixedly coupled to one dome element, and the spacebar may be fixedly coupled to four dome elements.

The term fixedly coupled are to be understood as the key element may be resting on the dome element and/or it may be glued or vulcanized to the dome element and/or welded to the dome element.

In an embodiment, the dome elements 106, 107, 109 provides control of the dimensions in which the key elements 101, 108 may move in. The dome elements 106, 107, 109 may in an embodiment restrict the direction in which the key elements 101, 108 may move. In an embodiment, the direction in which the key elements may move may be the direction 110 perpendicular to the rubber mat 105 or substantially perpendicular to the rubber mat 105 e.g. 90 degrees+/−5 degrees.

In order to have the dome element deform, an external force provided by a user 103 pressing the associated key element, is required. The dome elements may be made of a soft plastic or rubber or any other material capable of deforming substantially along the direction of movement 110 when an external force having a component in the direction of movement 110 is applied to the key element 101. In an embodiment, the dome element 106 may be such as to require a threshold force in the direction of movement 110 before deforming thereby providing a tactile response to a user applying a force to the key element 101 and making the dome element able to sustain the weight of the key element 101 without any substantial deformation in the direction of movement 110 of the key element when an external force is not applied.

Thereby, the dome element 106, 107, 109 is able to provide a tactile feedback in response to a user action e.g. a user pressing the key element.

The key element 101 may be made of a material harder than the dome element. For example, the key element 101 may be made of melamine resin.

Additionally, the keyboard 197 may be communicatively coupled to the key-value generating unit 196 via a communication link 193. In an embodiment, the communication link 193 is established via a short-range radio transmitter/receiver included in the keyboard and the key-value generating unit 196. The communication link 193 may be established between a Bluetooth 195 transmitter and receiver in the keyboard 197 and a similar 194 in the key-value generating unit 196. In an alternative embodiment, the communicatively coupling comprises a data-cable, such as a USB cable or the like, connected to the keyboard 197 and the key-value generating unit 196.

FIG. 35b shows a circular cross-sectional view along the X-X axis of a dome element 106, 107, 109. The dome element 106, 107, 109 may be open in both ends i.e. the end 117 facing the key element 101, 109 and the end 118 facing the rubber mat 105.

In an embodiment, the keyboard 197 may additionally comprise a printed circuit board (PCB) 115 comprising a plurality of pads 119 for determining whether a key element 101, 108 has been pressed.

Each pad 119 comprises a first and a second pad part, and the first pad part is electrically isolated from the second pad part. When a key element 101 is depressed, a conductive element 120 (fixedly connected to the mat 105 in proximity to the key element 101) is brought into contact with the first and second pad parts thereby short circuiting the first and second pad parts of at least one pad 119, thereby enabling detection of the depressed key element 101.

As seen in FIG. 35 a), the elastic and flexible mat 105 may be positioned between the PCB 115 and the plurality of key elements 101, 108. The PCB 115 may be placed below the flexible mat 105.

The PCB circuit may be communicatively coupled to the short-range radio transmitter/receiver 195 via a wireless and/or wired communication link such as Bluetooth or cable. The value of a detected depressed key element 101 may be transmitted from the PCB circuit to the processing unit 1001 for further processing.

The key-value generating unit 196 comprises a short-range radio transmitter/receiver 194 as disclosed above.

Additionally, the key-value generating unit 196 may comprise a light projecting unit 192. The light projector 192 is adapted to project a key-value (e.g. an alpha-numeric value) onto at least one of the key elements 101 of the keyboard 197. The light projector 192 may for example provide the key-values of all the key elements 101 of the keyboard 197 by projecting the key-values onto the key-elements.

In an embodiment, the key-value generating unit 196 may comprise a mobile communication unit, such as a mobile telephone, and wherein light projector comprised in the mobile communication unit 196 comprises a dynamic RGB colour image projector.

In an embodiment, the key-value generating unit 196 may comprise a processing unit 1001. The processing unit 1001 may be communicatively coupled to the short-range radio transmitter/receiver 194 via a wire. The processing unit 1001 may thus receive date about which key elements have been depressed. Additionally, the processing unit 1001 may be communicatively coupled to the light projector via a wire to thereby determine which characters are to be displayed on which key elements 101 by the light projector 192. The processing unit 1001 may provide a plurality of control signals to the light projector 192 to control the key-values transmitted to the respective key elements 101.

Thereby, the key-value generating unit 196 controls the alpha-numeric value displayed on each key element 101 and the processing unit 1001 may keep track of which alpha-numeric value is associated with which key element 101. Thereby, the processing unit 1001 may keep track of the key elements that are depressed together with the alpha-numeric value represented by the key element 101 at the time of depression.

In an embodiment, the key-value generating unit 196 further comprises a power providing unit such as a connection to a power grid and/or an battery.

In an additional embodiment, the keyboard further contains a power providing unit such as a connection to a power grid and/or an battery.

In the embodiment of FIG. 35 a) in which the key elements 101 comprises a reflecting part 102, the key-value generating unit 196 may be positioned approximately perpendicular to and above the plane of the key board 197 i.e. at an angle of 90 degrees+/−5 degrees and such that light from the light projector 192 of the key-value generating unit 196 may be incident on the reflecting part 102 of the key elements 101.

In an embodiment, the reflecting part 102 may comprise a diffuse-reflecting layer. In the above and below, a diffuse-reflecting layer is a reflecting layer reflecting electromagnetic radiation in all directions. Thereby, the light projector 192 may project light onto the reflecting parts 102 which light may diffusely reflect the light incident from the light projector 192. At least a part of the diffusively-reflected light may be reflected towards a user 103.

In the embodiment of FIG. 35 a) comprising key elements 101 comprising reflecting part 102, the PCB may be cast in one piece without perforations.

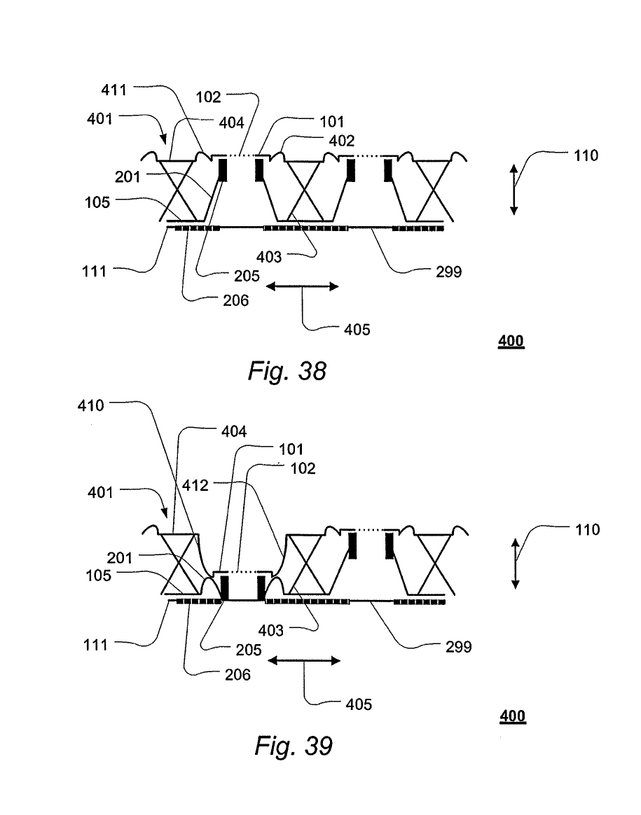

FIG. 38 shows an embodiment 400 of the keyboard 197 further comprising a layer 401 in which the key elements 101 are included.

The embodiment 400 comprises a rubber mat 105 further comprising fixators 205 to which the key elements 101 may be fixated e.g. by gluing, vulcanization, welding or the like. The distance between to opposing inner sides of the fixators 205 may correspond to size of the transparent part 102 in the respective dimensions of the plane containing the transparent part 102. The fixators 205 may be made of a hard plastic or rubber material such as to provide a stable platform on which the key element 101 may be placed.

In an embodiment, the fixators 205 are able to conduct an electric current. For example, the hard plastic or rubber may be doped with a metallic powder such as iron or the like. Alternatively or additionally, the fixators 205 may contain an electric wire providing an electrically closed loop.

The keyboard may comprise a detection unit 111 which as disclosed above may be a PCB. Alternatively or additionally, the detection unit 111 may be a capacitive detection unit comprising openings 299 defined by an electrically insulating layer 206, such as a plastic or rubber, deposited on the detection unit 111 comprising fields corresponding to the fixators 205 of the respective key elements 101. Thereby, when a key element 101 is depressed, the capacitive detection unit 111 may detect it due to changes in the electric field corresponding to the opening 299 of the respective depressed key element 101.

Thereby, the keyboard of FIG. 38 may be used in connection with capacitive detection of which key elements have been depressed. This may be an alternative or additional key element depression detection to the PCB detection.

The layer 401 may be comprise a collar/ridge 402. The collar/ridge 402 is made of an elastic and flexible material such as rubber. Additionally, the layer 401 may comprise a rigid part 404 made of a hard and non-flexible plastic.

Between the rigid part 404 and the mat 105 (in the direction 110), supporting elements 403 may be positioned i.e. between the dome elements 2001 of the mat 105 (in the direction 406). The supporting elements 403 supports the layer 401. The supporting elements 403 may be glued or vulcanized or welded to the rigid part 404 and the mat 105.

The key elements 101 comprises a transparent part 102 i.e. a transparent window. The key elements 101 may be glued or vulcanized or welded to the collar/ridge 402.

In an embodiment, the collar/ridge 402 is made of a transparent elastic and flexible material.

FIG. 39 shows an embodiment in which a key element 101 of the keyboard 400 is in a depressed state. In the depressed state, the dome element 2001 of the depressed key element 101 and the collar/ridge 402 of the depressed key 101 are flexing to provide the tactile feedback of the key element 101.

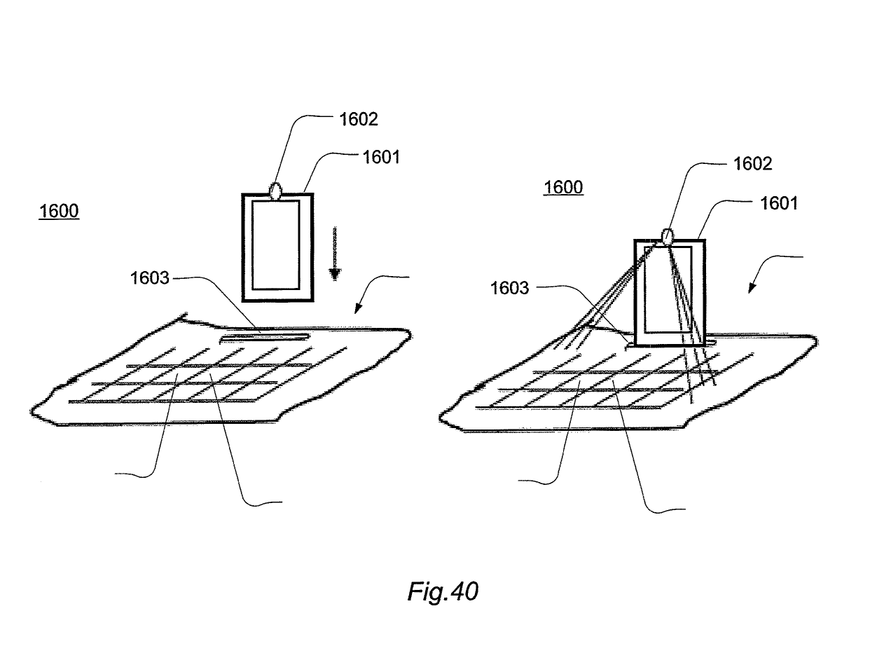

FIG. 40 a) shows a system 1600 comprising a mobile communication device 1601 such as a mobile telephone comprising a light projector 1602. The system 1600 further comprises a device 197 comprising a plurality of diffuse reflecting parts 101.

The device 197 may comprise a docking bay 1603 for a mobile communication device 1601 comprising a processor such as a mobile telephone, a portable digital assistant or the like. The docking bay 1603 may be in the plane of the device 197.

In an embodiment, the device 197 comprises a keyboard as described under FIG. 35 a) comprising a diffuse reflecting layer in the key elements 101. The keyboard 197 further comprises the docking bay 1603 into which the mobile communication device 1601 may be placed. The docking bay 1603 may comprise a socket such as a USB or mini-USB socket enabling communicative coupling with a mobile communication device 1601 placed in the docking bay 1603.

In an embodiment, the device 197 comprises a planar surface capable of reflecting incident light. The planar surface may be a plate of plastic or metal comprising a diffuse reflecting surface. A detector unit may be included in the planar surface enabling detection of which part of the planar surface that are touched by a user.

In an embodiment, the detector unit comprises an IR light source providing an IR plane above and parallel to the planar surface. The IR plane may be 1 mm above the planar surface. When a user touches a part of the planar surface, IR light is reflected from the IR plane and some of the reflected IR light is collected by a CMOS or CCD detector. Based on the detected light, the position of the touched part of the planar surface may be determined by a processing unit.

In an embodiment, the detector unit comprises two metallic and electrically conductive layers separated by a narrow gap and positioned on the planar surface. When an object, such as a finger, presses down on a point on the planar surface, the two metallic layers become connected at that point: the conductive layers then behaves as a pair of voltage dividers with connected outputs. This causes a change in the electrical current which is registered as a touch event and sent to a controller for processing.

In an embodiment, the detector unit comprises a Surface Acoustic Wave (SAW) generator positioned in connection with the planar surface such that ultrasonic waves pass over the planar surface. When an object such as a finger touches the planar surface, a portion of the SAW is absorbed. This change in the ultrasonic waves registers the position of the touch event and sends this information to the controller for processing.

In an embodiment, the detector unit comprises an insulator such as glass, coated with a transparent conductor such as indium tin oxide (ITO) and positioned on the planar surface. As the human body is a conductor, a finger touching the planar surface results in a distortion of the finger's electrostatic field, measurable as a change in capacitance. Different technologies may be used to determine the location of the touch. The location can be passed to a processing unit adapted to calculate where the user's touch is positioned on the planar surface.

When placed in the docking bay 1603, as shown in FIG. 40 b), the mobile communication device 1601 may be communicatively coupled to the device 197 via the socket. Thereby, the mobile communication device 1601 may be communicatively coupled via a data bus to the PCB of the keyboard or via a data bus to the IR detector of the planar surface. Thus detection of which key elements 101 of the keyboard are depressed or which parts of the planar surface that are touched may be determined by the mobile communication device 1601.

Additionally, the light projector 1602 of the mobile communication device 1601 may illuminate the reflecting layer 102 and thus may define the value of the key elements 101 of the keyboard 197 or the value of one or more parts of the planar surface. Thereby the light projector 1602 may provide the values of the key elements 101 in keyboard 197 e.g. alpha-numeric values, or the values of the parts of the planar surface e.g. alpha-numeric values or gaming piece values or gaming board or the like.

The mobile communication device 1601 may further keep track of which key elements or parts of the planar surface are provided with which values. This may be achieved via the docking bay 1603 which may be communicatively coupled to the PCB 115 of the keyboard or to the IR detector of the planar surface. When connected to the docking bay 1603, the mobile communication 1601 may be communicatively coupled via the docking bay 1603 to the PCB 115 or the IR detector. Further, the mobile communication device 1601 controls the light projector included in the mobile communication device 1601. In an embodiment, the mobile communication device 1601 may be communicatively coupled directly to the PCB 115 or the IR detector via the data bus. The communicative coupling may be established using Bluetooth or a data cable or the like.

The mobile communication device 1601 may thus perform the role of the processing unit 1001 in FIG. 35 a) by controlling the light projector 1602 and by detecting the touched value of a key element 101 or a part of the planar surface via its communicative coupling to the PCB 115 or the IR detector. Thus, the mobile communication device may control which values that are associated with which key elements 101 or which parts of the planar surface. Further, the mobile communication device 1601 may keep track of which key elements 101/parts of the planar surface, a user 103 depresses and thus the value represented by the key element 101/part of the planar surface at the time of depression. This may be done via the communicational link to the PCB 115 or the IR detector via the data bus.

Thereby, the mobile communication device 1601 may provide the processing power of the system 1600 together with the values of the key elements 101 in the keyboard 197 or the parts of the planar surface.

In an embodiment, the keyboard 197 or the planar surface may comprise a power source such as a battery pack. Thereby, the mobile communication device 1601 may be recharged when placed in the docking bay 1603 during which the light projector 1602 may provide the values of the key elements 101 or the parts of the planar surface.

In an embodiment, a first mobile communication device 1601 placed in a docking bay of a first planar surface device 197 is communicatively coupled to a second mobile communication device 1601 placed in a docking bay of a second planar surface device 197 via a communication link such as Bluetooth, LAN, WAN, cable or the like.

In this embodiment, the pico projector of each of the communication devices is adapted to project a common gaming surface (e.g. a Chess board) and a first set of gaming pieces associated with the first mobile communication device and a second set of gaming pieces associated with the second mobile communication device. Thereby, a user of the first mobile communication unit and a user of the second mobile communication unit may play a game against each other without having to be in close proximity to each other. The first and second mobile communication devices may exchange information regarding position or other parameters of the gaming pieces via the communication link.

FIG. 36 shows an embodiment of a mobile communication device 2000 comprising a smart phone 2001 as seen in FIG. 36 a) where the smart phone 2001 is seen from the front. The smart phone 2001 comprises a display 2003 such as a touch sensitive display, and a number of keys 2004 which may be activated manually by a user e.g. by pressing a key.

The smart phone 2001 further comprises a pico-projector aperture 2002 (a circular aperture) as seen in FIG. 36 b) where the smart phone is seen from the top. The smart phone further comprises a pico-projector and a built-in lens enabling the pico-projector to project out through the aperture 2002.

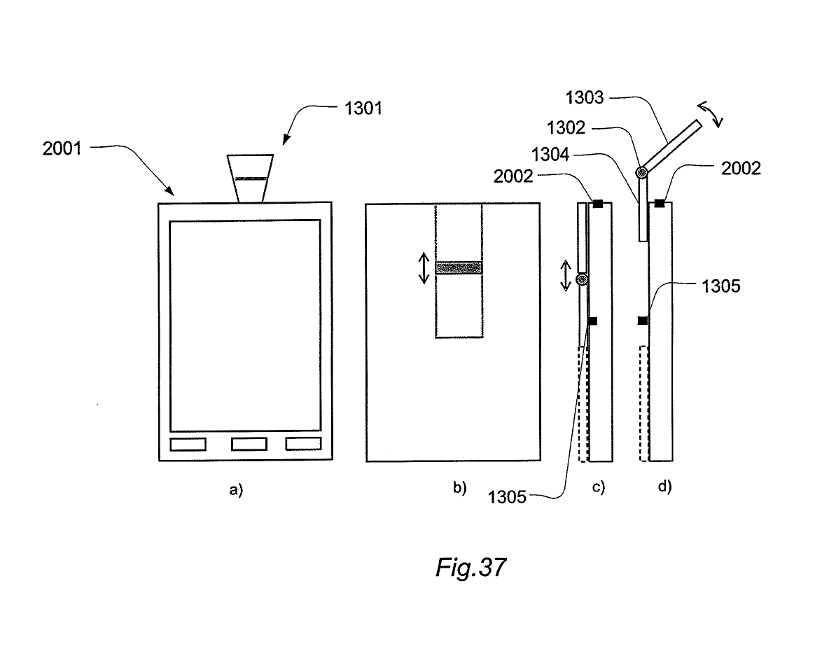

FIG. 37 shows the smart phone 2000 of FIG. 36 further comprising a hinged mirror 1031. The hinged mirror may 1031 slide along the back side (opposite to the display 2003 side of the smart phone) of the smart phone such that the hinged mirror 1031 may be in a slid-out state as seen FIGS. 35 a) and 35d), and in a slid-in state as seen in FIGS. 35 b) and c). In an embodiment, the hinged mirror 1031 may slide along a rail or the like. The hinged mirror 1031 may be slid between the slid-in state and the slid-out state by a user's thumb or the like. Both in the slid-in state and in the slid-out state, the hinged mirror 1031 may be clicked in place such as to prevent the hinged mirror 1031 to move from its present state without the appliance of an external force such as provided by the user's thumb or the like. Thereby, the hinged mirror 1031 may remain in the slid-in state or the slid-out state until a user provides a force to it.

The hinged mirror 1031 may comprise a first mirror part 1033, a hinge 1032 and a second mirror part 1034. The first mirror part 1033 may be the outer part of the hinged mirror 1031 i.e. the part fixedly connected to the hinge 1032, and the second minor part 1034 may be the inner part of the hinged mirror 1031 i.e. the part fixedly connected to the hinge 1032 and the smart phone 2001 The first mirror part 1033 is able to rotate with respect to the hinge 1032 as seen in FIG. 37 d) such that it may be placed at a non-parallel angle with respect to the light emitted from the pico-projector 2002. Thereby, the first mirror part 1033 of the hinged mirror 1031 may be able to redirect a dynamic RGB colour image projection from the pico-projector onto a surface in front of the smart phone 2000. The projected dynamic RGB colour image may be projected onto a keyboard as disclosed with respect to FIGS. 35 and 40 or onto a planar surface as disclosed with respect to FIG. 40.

As indicated by the double arrows in FIG. 37 d), the first mirror part 1034 of the hinged mirror 1031 be tilted at an arbitrary angle around the hinge 1032.

In an embodiment, the smart phone 2001 comprises a contact 1035 positioned in the sliding path of the hinged mirror 1031 such that the contact is activated (depressed) when the hinged mirror 1031 is in its slid-in state as indicated in FIG. 37 c) and un-activated (un-pressed) when the hinged mirror 1031 is in its slid-out state as indicated in FIG. 37 d). When the contact 1035 is un-activated i.e. when the hinged mirror 1031 is in its slid-out state, then the pico-projector of the smart phone 2001 automatically switches on such that a dynamic RGB colour image is projected onto the surface in front of the smart phone 2000.

When the contact 1035 is activated, then the pico-projector may be switched off or its on/off state may be controlled by e.g. the user or a program or the like.

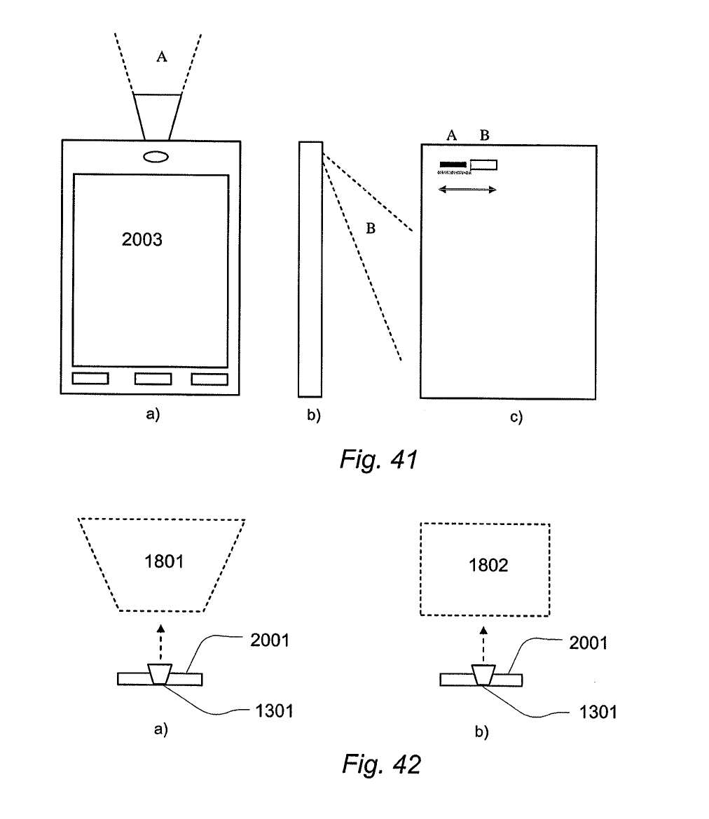

FIG. 41 a) shows a front view of the smart phone 2001 in which the top of the smart phone 2001 comprises a pico-projector as also seen in FIG. 36 b). FIG. 41 c) shows the back (the side opposite of the display) of the smart phone which comprises a mechanical switch for redirecting the dynamic RGB colour image projection emitted by the pico-projector. When the switch is in a first position e.g. position A, then the smart phone may project a dynamic RGB colour image out from the top as seen in FIG. 41 a) of the smart phone. When the switch is in a second position e.g. position B, then a mirror may be slid in front of the aperture 2002 of the smart phone 2001 such that the dynamic RGB colour image may be projected onto a surface in front of the smart phone 2001 as seen in FIG. 41 b).

FIG. 42 a) shows the effect of skew angles 1801 which may occur when projecting the dynamic RGB colour image from the pico-projector onto the surface in front of the smart phone 2001 using a mirror 1031. Projected light on the surface is indicated with dotted lines. The smart phone 2001 is seen from the top as e.g. shown in FIG. 36 b). And the surface is positioned perpendicular to the display plane of the smart phone.

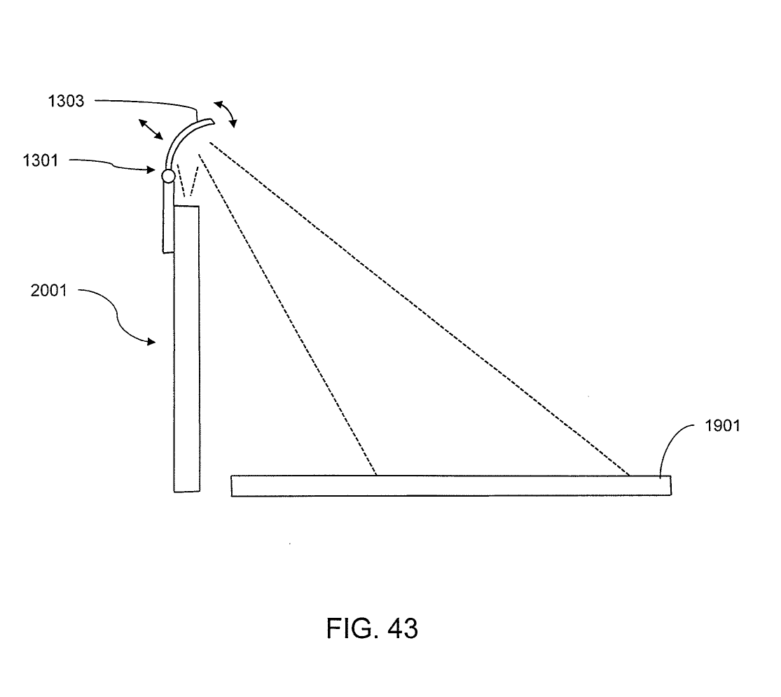

FIG. 43 shows an embodiment of a smart phone 2001 comprising a hinged mirror 1031. In this embodiment, the first mirror part 1033 of the hinged mirror 1031 is made of a flexible material which may be bent. Thereby, the first mirror part 1033 may be bent e.g. by the user in order to correct the skew angle 1801 and thereby to produce an un-skewed projection 1802 on the surface 1901. In the embodiment, the projected light is indicated by dashed lines.

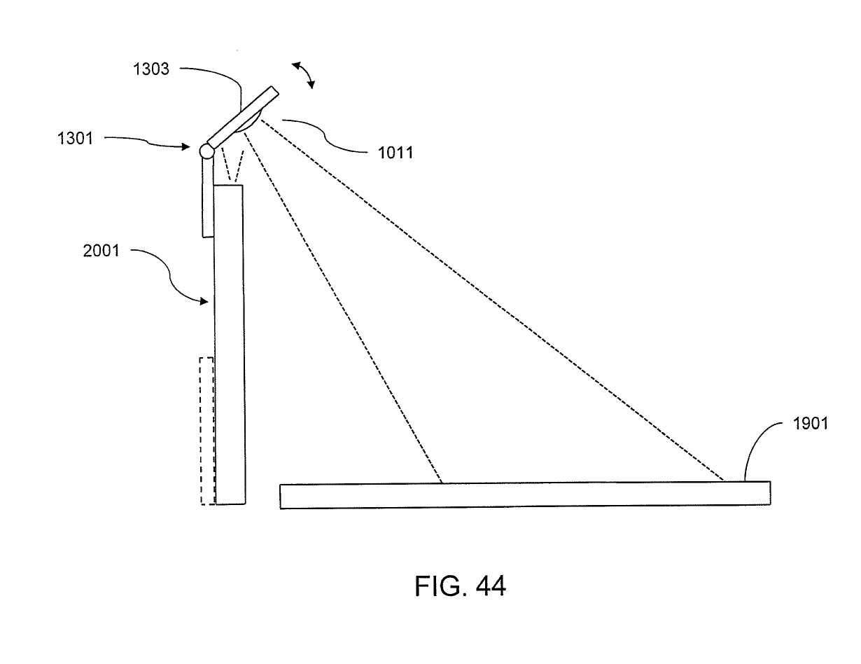

FIG. 44 shows an embodiment of a smart phone 2001 comprising a hinged mirror 1031. In this embodiment, the first mirror part 1033 of the hinged mirror 1031 comprises a thin phase shifting or lensing material coating 1011 such that the first mirror part 1033 may correct for the skew angles that is encountered when projecting the dynamic RGB colour image from the pico-projector onto the surface 1901. The thickness of the phase shifting coating may be below 1 mm. The projected light is indicated with dashed lines.

In an embodiment, the phase shifting or lensing material coating 1011 may be implemented as one or more of the following: a thin phase shifting transmission material superposed the first part mirror 1033; tiny mechanical deformations of the first mirror part 1033 e.g. by electrical induced stress in the first mirror part by an electrode; a meta-material designed for broadband illumination; a sub-wavelength processed first mirror part 1033 surface, and/or a computer-generated diffractive structure.

In an embodiment, the first mirror part 1033 may be made of a flexible material which may be bent and it may comprise a thin phase shifting or lensing material coating 1011. Thereby, the thin phase shifting or lensing material coating 1011 may correct for skew angles and if required, a user may fine tune the correction by bending the first mirror part 1033.

FIG. 42 b) shows projection of a dynamic RGB colour image from the pico-projector onto the surface 1901 in front of the smart phone 2001 using a hinged mirror 1031 comprising a first mirror part 1033 correcting the skew angle 1801 thereby resulting in an un-skewed projection.

In any of the above embodiments illustrated in any of FIGS. 35-44, the light projector may be a pico projector e.g. a handheld projector. In an embodiment, the pico projector may be included in a portable device such as mobile telephone, a PDA or the like.

Although some embodiments have been described and shown in detail, the invention is not restricted to them, but may also be embodied in other ways within the scope of the subject matter defined in the following claims. In particular, it is to be understood that other embodiments may be utilised and structural and functional modifications may be made without departing from the scope of the present invention.

In device claims enumerating several means, several of these means can be embodied by one and the same item of hardware. The mere fact that certain measures are recited in mutually different dependent claims or described in different embodiments does not indicate that a combination of these measures cannot be used to advantage.

It should be emphasized that the term “comprises/comprising” when used in this specification is taken to specify the presence of stated features, integers, steps or components but does not preclude the presence or addition of one or more other features, integers, steps, components or groups thereof.

1. Input device comprising
a plurality of activation parts including a first activation part and a second activation part, each activation part being configured for enabling depression of the activation part by a user, wherein depression of the activation part provides tactile feedback to the user,
at least one registration part configured for individual registration of depression of activation parts, and
at least one image displaying part including a first image displaying part configured for displaying a first image to the user, the display of the first image being configured to be perceived by the user as a three-dimensional or a pseudo three-dimensional first image at the first activation part, the first image including a first primary label for the first activation part, the first image displaying part being configured to display the first image dynamically, such that the first primary label may be adapted or amended during operation of the input device.

2. The input device according to claim 1, wherein the input device is a keyboard with a plurality of keys including a first key and a second key, the first key including a first cap part and the second key including a second cap part, wherein the first activation part forms the first cap part and the second activation part forms the second cap part.

3. The input device according to claim 1, wherein the at least one image displaying part being configured for displaying a second image to the user, the display of the second image being configured to be perceived by the user as a three-dimensional or a pseudo three-dimensional second image at the second activation part, the second image including a second primary label for the second activation part.

4. The input device according to claim 1, wherein the at least one image displaying part comprises a plurality of image displaying parts including a second image displaying part configured to display the second image to the user.

5. The input device according to claim 4, wherein the plurality of imaging displaying parts comprises an image displaying part for each activation part.

6. (canceled)

7. (canceled)

8. The input device according to claim 1, wherein the at least one image displaying part comprises at least one display.

9. The input device according to claim 8, wherein the at least one image displaying part comprises a plurality of image displaying parts including a second image displaying part configured to display the second image to the user and the at least one display is arranged in an integrated display having an individual display part for each image displaying part.

10. The input device according to claim 8, wherein the at least one display comprises at least two stacked displays.

11. The input device according to claim 1, wherein the at least one image displaying part comprises at least one light scattering part including a first light scattering part for scattering incident light.

12. The input device according to claim 11, wherein the at least one image displaying part comprises a plurality of image displaying parts including a second image displaying part configured to display the second image to the user and the at least one light scattering part comprises a light scattering part for each image displaying part.

13. The input device according to claim 11, wherein the at least one light scattering part is configured to at least partly transmit incident light or is configured to at least partly reflect incident light.

14. The input device according to claim 11, comprising at least one light emitting part including a first light emitting part for emitting light onto the at least one light scattering part for displaying the first image.

15. The input device according to claim 14, comprising at least one optical element for focusing light from the at least one light emitting part onto the at least one light scattering part.

16. The input device according to claim 14, comprising a plurality of light redirecting structures, such as a plurality of mirrors, for redirecting light from the at least one light emitting part onto the at least one light scattering part.

17. The input device according to claim 1, comprising a plurality of waveguide fibres having distal ends forming the at least one image displaying part, the plurality of waveguide fibres being configured for redirecting light from at least one light emitting part for displaying the first image at the distal ends of the waveguide fibres.

18. The input device according to claim 1, wherein the at least one image displaying part is configured to displaying to the user the first image in form of a stereoscopic image, an auto-stereoscopic image, or a holographic image.

19. The input device according to claim 18, wherein the at least one image displaying part comprises a lenticular lens and/or a parallax barrier.

20. The input device according to claim 18, wherein the at least one image displaying part is configured to generate the auto-stereoscopic image by means of directional projection of light towards expected or detected positions of the eyes of the user.

21. The input device according to claim 3, wherein the input device is configured to present a group of labels that are used with a particular computer program.
